(19) United States
(12) Patent Application Publication
(10) Pub. No.: US 2019/0245774 A1
(43) Pub. Date: Aug. 8, 2019

(54) COMMUNICATION DEVICE AND COMMUNICATION NETWORK

(71) Applicant: Mitsubishi Electric Corporation, Tokyo (JP)

(72) Inventors: Tetsuyoshi SHIMOKAWA, Tokyo (JP); Daisuke OSAGAWA, Tokyo (JP)

(73) Assignee: Mitsubishi Electric Corporation, Tokyo (JP)

(21) Appl. No.: 16/342,212

(22) PCT Filed: Oct. 2, 2017
(86) PCT No.: PCT/JP2017/035858

§ 371 Date: Apr. 16, 2019

(51) Int. Cl. H04L 12/727; H04W 40/12; H04L 12/723; H04L 12/721; H04L 12/753

(52) U.S. Cl. CPC H04L 45/121; H04W 40/12; H04L 45/48; H04L 45/70; H04L 45/502

(57) ABSTRACT

A communication device for forming a communication network, which generates a search frame, which is a frame for searching for a communication path in setting a communication path to/from another communication device, transmits the search frame to other communication devices, and selects a communication path with a shortest delay time to each of the other communication devices on the basis of information in the search frame having passed through other communication devices and returned to the communication device.

### FIELD

The present invention relates to communication devices that form an industrial network and to a communication network.

### BACKGROUND

Various communication networks including industrial networks can be classified into several types depending on conditions of connections between communication devices forming the communication network. Typical examples thereof include bus-type, star-type, tree-type, ring-type, and mesh-type communication networks.

Among such communication networks, a mesh-type communication network enables flexible selection of communication paths between communication devices forming the network, and various methods for selecting communication paths have been proposed. For example, Patent Literature 1 describes a method for selecting a path in a case where a mesh-type communication network is applied to form a sensor network.

In a communication network, a communication path needs to be selected in such a manner that a looped path will not be set. The Spanning Tree Protocol (STP) is present as a communication protocol to avoid setting of a looped path. The STP generates a network having a logical tree structure in a communication network having a loop-type or a mesh-type physical configuration. Specifically, with the STP, a route path cost, which is a sum of path costs depending on the communication speed from a communication device that is a source in the communication network to a communication device connected with the source communication device, is calculated, and a path with the smallest route path cost is selected.

### CITATION LIST

### Patent Literature

Patent Literature 1: Japanese Patent Application Laid-open No. 2012-217164

### SUMMARY

### Technical Problem

An industrial network is typically constituted by a communication device connected with a controller, and communication devices connected with industrial machines that are controlled devices. The communication device connected with the controller may be called a master communication device or the like, and the communication devices connected with the industrial machines may be called slave communication devices or the like. Note that the controller and the industrial machines may have the functions of the communication devices. In such a case, the controller corresponds to the master communication device, and the industrial machines correspond to the slave communication devices.

To achieve accurate control of the industrial machines in a case where such an industrial network is formed by using a mesh-type communication network, the master communication device needs to collect information on communication paths to the individual slave communication devices to obtain the entire network configuration, and select a path suitable for communication for control from among a plurality of selectable communication paths.

When selecting a path by using the STP, however, the master communication device can select communication paths of a tree structure but cannot collect information on communication paths to the individual slave communication devices and thus cannot obtain the entire network configuration. Thus, in a case where a plurality of selectable communication paths are present, the master communication device cannot know such selectable communication paths. There is thus a problem in which selection of a communication path suitable for an industrial network is not guaranteed.

The present invention has been made in view of the above, and an object thereof is to provide a communication device capable of selecting a communication path suitable for an industrial network.

### Solution to Problem

To solve the aforementioned problems and achieve the object, a communication device of the present invention forms a communication network. The communication device generates a search frame, which is a frame for searching for a communication path in setting a communication path to/from another communication device, transmits the search frame to other communication devices, and selects a communication path with a shortest delay time to each of the other communication devices on the basis of information in the search frame having passed through other communication devices and returned to the communication device.

### Advantageous Effects of Invention

A communication device according to the present invention produces an effect of being capable of selecting a communication path suitable for an industrial network.

### BRIEF DESCRIPTION OF DRAWINGS

FIG. 1 is a conceptual diagram of a communication device according to the present invention.

FIG. 2 is a diagram illustrating an example configuration of the communication device according to the present invention.

FIG. 3 is a diagram illustrating an example configuration of a communication network to which the communication device is applied.

FIG. 4 is a diagram illustrating an example structure of information included in a search frame.

FIG. 5 is a diagram illustrating an example of information included in a search frame after being transferred by a slave device.

FIG. 6 is a diagram illustrating another example of information included in a search frame after being transferred by a slave device.

FIG. 7 is a flowchart illustrating operation of searching for paths performed by communication devices according to the present invention.

FIG. 8 is a diagram illustrating operation of a communication device that is a source of a search frame.

FIG. 9 is a diagram illustrating operations of communication devices that have received respective search frames illustrated in FIG. 8.

FIG. 10 is a diagram illustrating operations of communication devices that have received respective search frames illustrated in FIG. 9.

FIG. 11 is a first figure illustrating operations of communication devices that have received search frames illustrated in FIG. 10.

FIG. 12 is a second figure illustrating operations of the communication devices that have received the search frames illustrated in FIG. 10.

FIG. 13 is a first figure illustrating operations of communication devices that have received search frames illustrated in FIG. 11.

FIG. 14 is a second figure illustrating operations of the communication devices that have received the search frames illustrated in FIG. 11.

FIG. 15 is a diagram illustrating an example of information on selectable paths, which are collected through path searching operation.

FIG. 16 is a diagram illustrating a first communication path on which measurement of transmission delay times is performed.

FIG. 17 is a diagram illustrating a second communication path on which measurement of transmission delay times is performed.

FIG. 18 is a diagram illustrating a third communication path on which measurement of transmission delay times is performed.

FIG. 19 is a diagram illustrating a fourth communication path on which measurement of transmission delay times is performed.

FIG. 20 is a diagram illustrating a fifth communication path on which measurement of transmission delay times is performed.

FIG. 21 is a diagram illustrating a sixth communication path on which measurement of transmission delay times is performed.

FIG. 22 is a table illustrating an example of results of measurement of transmission delay times.

FIG. 23 is a diagram illustrating paths selected on the basis of the measurement results illustrated in FIG. 22.

FIG. 24 is a diagram illustrating an example configuration of hardware for implementing a communication device.

FIG. 25 is a diagram illustrating another example configuration of hardware for implementing a communication device.

### DESCRIPTION OF EMBODIMENTS

A communication device and a communication network according to an embodiment of the present invention will be described in detail below with reference to the drawings. Note that the present invention is not limited to the embodiment.

### Embodiment

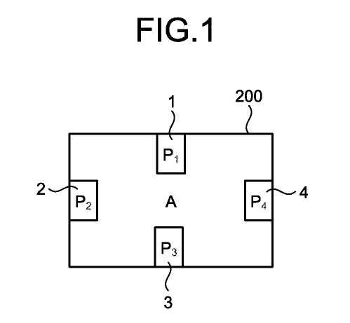

FIG. 1 is a conceptual diagram illustrating a communication device according to the present invention. A communication device 200 according to the present invention includes a plurality of transmission/reception ports 1 to 4, which are communication ports. “A” in FIG. 1 represents identification information of the communication device 200. Note that the number of transmission/reception ports is not limited to four; in the description below, however, the number of transmission/reception ports included in the communication device is assumed to be four. In addition, the four transmission/reception ports are represented by P₁ to P₄. The communication device 200 forms an industrial network.

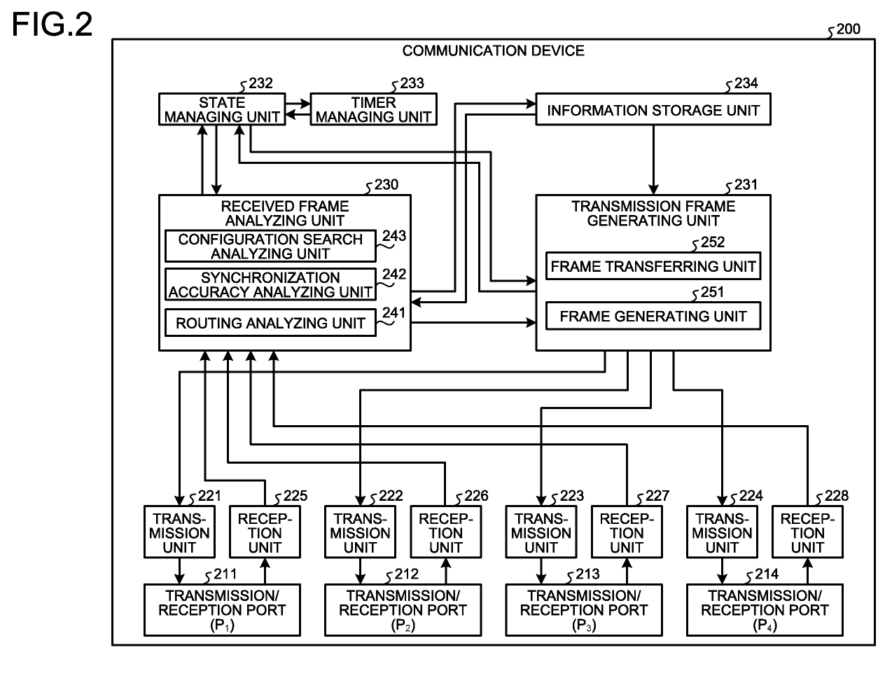

FIG. 2 is a diagram illustrating an example configuration of the communication device according to the present invention. The communication device 200 includes the transmission/reception ports 211 to 214, transmission units 221 to 224, reception units 225 to 228, a received frame analyzing unit 230, a transmission frame generating unit 231, a state managing unit 232, a timer managing unit 233, and in information storage unit 234.

The transmission/reception ports 211 to 214 correspond to the transmission/reception ports 1 to 4, respectively, illustrated in FIG. 1. The transmission/reception ports 211 to 214 each output frames to a communication path connected thereto, and receive frames from the communication path.

The transmission units 221 to 224 transmit frames input from the transmission frame generating unit 231 to other communication devices.

The reception units 225 to 228 receive frames transmitted by other communication devices, and output the received frames to the received frame analyzing unit 230.

The received frame analyzing unit 230 includes a routing analyzing unit 241, a synchronization accuracy analyzing unit 242, and a configuration search analyzing unit 243.

The routing analyzing unit 241 determines whether each of frames received from the reception units 225 to 228 during normal operation is a frame to be received, a frame to be transferred or a frame to be discarded. The normal operation is a state in which setting of communication paths to/from the other communication devices that form the industrial network is completed and frames can be transmitted and received via the set communication paths. When a received frame is a frame to be received, the routing analyzing unit 241 retrieves information from the frame and outputs the information to the information storage unit 234, and the information storage unit 234 stores the information. When a received frame is a frame to be transferred, the routing analyzing unit 241 outputs the frame to a frame transferring unit 252, which will be described later, of the transmission frame generating unit 231. In this case, the frame output by the routing analyzing unit 241 is transferred to another communication device by the frame transferring unit 252. When a received frame is a frame to be discarded, the routing analyzing unit 241 discards the frame.

In a case where a plurality of communication paths to a communication device are present, the synchronization accuracy analyzing unit 242 uses each of the communication paths to measure a transmission delay time and the fluctuation of the transmission delay time of each of the transmission paths in transmission of the frame. The synchronization accuracy analyzing unit 242 measures the transmission delay time and the fluctuation by using the method described in the literature “International Publication No. WO 2015/162763”, for example.

Upon receiving a response frame in response to a frame for communication path search generated by a frame generating unit 251, which will be described later, of the transmission frame generating unit 231, from another communication device, the configuration search analyzing unit 243 analyzes the received response frame to analyze a path through which the response frame has been transmitted.

The transmission frame generating unit 231 includes the frame generating unit 251 and the frame transferring unit 252.

The frame generating unit 251 generates frames to be transmitted to other communication devices. Frames to be transmitted to other communication devices include a frame for searching for a communication path, a response frame in response to a frame for searching for a communication path, and the like.

The frame transferring unit 252 performs a transfer process on a frame determined to be a frame to be transferred by the routing analyzing unit 241 of the received frame analyzing unit 230. The frame transferring unit 252 also performs the transfer process on a frame for communication path search received from another communication device.

The state managing unit 232 manages the operation state of the communication device 200 and the operation states of each of the transmission/reception ports 211 to 214. The types of the operation state of the communication device 200 include a setting state in which an operation for setting a communication path to/from another communication device included in the industrial network is performed, and a normal state in which communication with another communication device by transmission/reception of frames via a set communication path is performed. The setting state includes a state in which an operation for searching for a communication path to/from another communication device is performed, and a state in which a transmission delay on each of found communication paths is measured and a communication path is selected and set on the basis of the measurement result. The operation state of each of the transmission/reception ports 211 to 214 indicates whether or not the transmission/reception port is transmitting/receiving a frame, that is, whether or not another communication device is connected with the transmission/reception port. The determination on whether or not another communication device is connected with each of the transmission/reception ports is made by the frame generating unit 251 of the transmission frame generating unit 231 by generating a frame for checking the presence of another communication device and transmitting the frame to each of the transmission/reception ports, for example. It is determined that another communication device is connected with a transmission/reception port that has received a response frame in response to the transmitted frame, and the transmission/reception port is in operation. In contrast, it is determined that no communication device is connected with a transmission/reception port that has received no response frame in response to the transmitted frame, and the transmission/reception port is not in operation.

The timer managing unit 233 holds a timer for measuring time, and outputs time information in response to a request from the state managing unit 232. Alternatively, the timer managing unit 233 may output time information in response to a request from a component other than the state managing unit 232, such as the received frame analyzing unit 230, for example.

The information storage unit 234 stores various items of information necessary for the communication device 200 to operate, such as information collected from other communication devices.

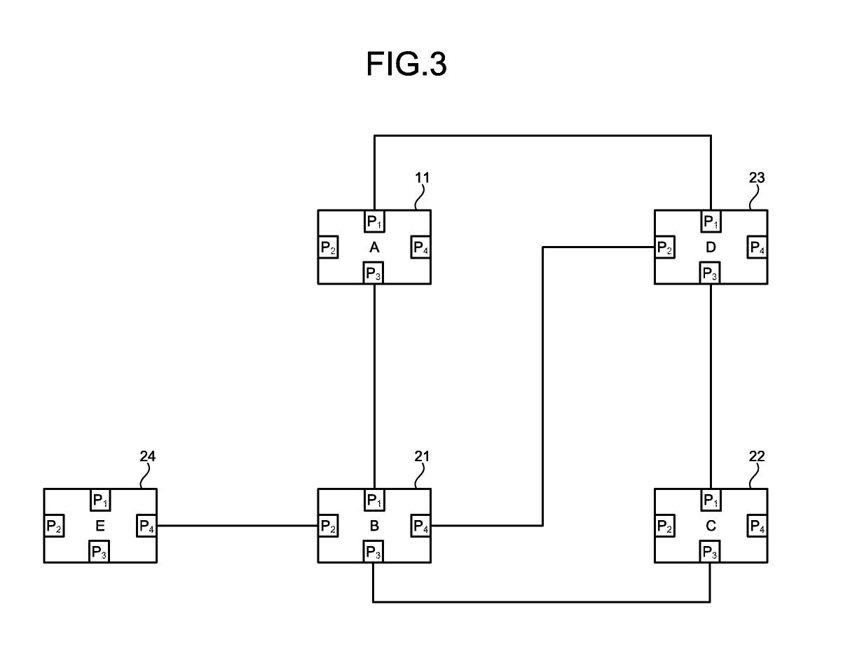

FIG. 3 is a diagram illustrating an example configuration of a communication network to which the communication device according to the embodiment is applied. In FIG. 3, physical connections between communication devices that forms the communication network are presented. The communication network illustrated in FIG. 3 includes communication devices 11, 21, 22, 23, and 24, which are communication devices according to the embodiment. The communication devices 11, 21, 22, 23, and 24 each correspond to the communication device 200 illustrated in FIG. 1. A to E in FIG. 3 represent identification information of the communication devices 11, 21, 22, 23, and 24, respectively. The communication device 11 operates as a master in the communication network, and the other communication devices 21 to 24 operate as slaves controlled by the communication device 11. In the description below, the communication device 11 may be referred to as a master device 11, and the communication devices 21 to 24 may be referred to as slave devices 21 to 24. In a case where the communication network is an industrial network, the master device 11 is a control device that is such a device as a programmable logic controller (PLC) or a personal computer. The slave devices 21 to 24 are such devices as vision sensors or drive units.

In the communication network illustrated in FIG. 3, a transmission/reception port P₁ of the communication device 11 and a transmission/reception port P₁ of the communication device 23 are connected with each other via a communication line, and a transmission/reception port P₃ of the communication device 11 and a transmission/reception port P₁ of the communication device 21 are connected with each other via the communication line. In addition, a transmission/reception port P₂ of the communication device 21 and a transmission/reception port P₄ of the communication device 24 are connected with each other via a communication line, and a transmission/reception port P₃ of the communication device 21 and a transmission/reception port P₃ of the communication device 22 are connected with each other via a communication line. In addition, a transmission/reception port P₄ of the communication device 21 and a transmission/reception port P₂ of the communication device 23 are connected with each other via a communication line, and a transmission/reception port P₁ of the communication device 22 and a transmission/reception port P₃ of the communication device 23 are connected with each other via a communication line.

Hereinafter, the operation of the master device 11 for selecting and setting a communication path to each of the slave devices 21 to 24 in the communication network having the configuration illustrated in FIG. 3 will be explained with reference to the drawings. In the embodiment, explanation will be made on an operation of the master device 11 for searching for selectable paths (path searching operation) and an operation of the master device 11 for selecting a path to be used from found paths (path selecting operation). Note that in the description below, the transmission/reception ports will simply be referred to as “ports”.

(Path Searching Operation)

First, the operation of the master device 11 for searching for selectable paths will be explained. To explain the operation briefly, the master device 11 transmits a search frame, which is a frame for searching for a communication path, through a port in operation, and the slave devices 21 to 24 in receipt of the search frame each output, that is, transfer the search frame through a port in operation, if any, other than the port that has received the search frame. If there is no port in operation other than the port that has received the search frame, the slave devices 21 to 24 output the search frame through the port that has received the search frame. In this process, the master device 11 generates a search frame including an ID (identification), which is its identification information, and transmission port information, which is information on the port through which the search frame is to be transmitted, and transmits the generated search frame through the port in operation. The slave devices 21 to 24 each add its ID, reception port information, which is information on the port that has received the search frame, and the transmission port information, which is information on the port through which the search frame is to be transmitted, to the search frame, and transfers the resulting search frame. In a case where a search frame that satisfies a predetermined condition is received, such as a case where a search frame that the slave devices 21 to 24 previously transferred is received again, however, the slave devices 21 to 24 transfer the search frame without adding the aforementioned information such as its ID. In this case, the slave devices 21 to 24 transfer the received search frame so that the search frame reaches the master device 11 by following the path through which the search frame was transmitted in the opposite direction. In a case where a search frame that the master device 11 previously transmitted is transferred by the slave devices 21 to 24 and returns to the master device 11, the master device 11 holds the IDs, the reception portion information and the transmission port information included in the returned search frame. Thereafter, the master device 11 analyzes the held IDs, reception port information, and transmission port information to determine selectable communication paths. Details of the operations described above will be explained separately with reference to specific examples.

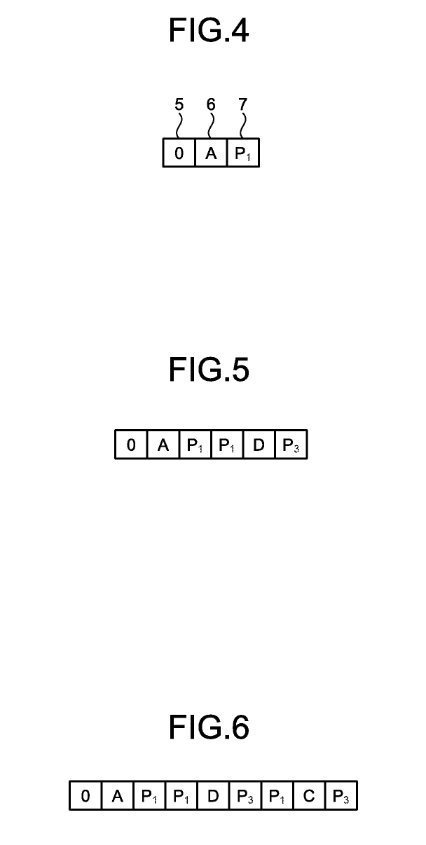

Explanation of the information included in a search frame will now be explained. FIG. 4 is a diagram illustrating an example structure of the information included in a search frame. FIG. 4 illustrates an example of information included in a search frame transmitted by the master device 11 to the slave device 23. As illustrated in FIG. 4, the search frame transmitted by the master device 11 to the slave device 23 includes information 5 indicating the port that has received the search frame, identification information 6 that is an ID of the master device 11, and information 7 indicating the port through which the search frame is to be transmitted. Since the search frame is generated in the master device 11, ‘0’ that is dummy data is set in the information 5 indicating the port that has received the search frame. Note that setting ‘0’ in the information 5 is one example, and other information may be set. ‘A’ that uniquely represents the master device 11 is set in the identification information 6. ‘P₁’ that represents the port with which the slave device 23 is connected is set in the information 7. Information set in the information 5 and the information 7 may be any information that can identify a port, and may be numerical values. In a case of a search frame transmitted by the master device 11 to the slave device 21, ‘P₃’ is set in the information 7. The search frame structure includes a header in addition to the information 5, the identification information 6, and the information 7 illustrated in FIG. 4. The header is added to the left of the information 5, that is, before the information 5. The structure illustrated in FIG. 4 is one example, and any structure may be used as long as the communication device to/from which the search frame is to be transmitted or has been received, the port that has received the search frame, and the port through which the search frame is to be transmitted can be recognized from the structure.

FIG. 5 is a diagram illustrating an example of information included in a search frame after being transferred by a slave device. FIG. 5 illustrates an example of information included in a search frame after being transmitted from the master device 11 and then transferred by the slave device 23 to the slave device 22. As illustrated in FIG. 5, the search frame after being transferred by the slave device 23 to the slave device 22 includes ‘P₁’, ‘D’, and ‘P₃’ in addition to the information illustrated in FIG. 4, that is, the information ‘0’, ‘A’, and ‘P₁’ included in the search frame received by the slave device 23. ‘P₁’, ‘D’, and ‘P₃’ are information added by the slave device 23. ‘P₁’ is the information of the port through which the slave device 23 has received the search frame, ‘D’ is the identification information of the slave device 23, and ‘P₃’ is the information of the port through which the slave device 23 has transmitted the search frame.

FIG. 6 is a diagram illustrating another example of information included in a search frame after being transferred by a slave device. FIG. 6 illustrates an example of information included in a search frame after being transmitted by the master device 11, then received by the slave device 22 via the slave device 23, and then transferred to the slave device 21. As illustrated in FIG. 6, the search frame after being transferred by the slave device 22 to the slave device 21 includes ‘P₁’, ‘C’, and ‘P₃’ in addition to the information illustrated in FIG. 5. ‘P₁’, ‘C’, and ‘P₃’ are information added by the slave device 22. ‘P₁’ is the information of the port through which the slave device 22 has received the search frame, ‘C’ is the identification information of the slave device 22, and ‘P₃’ is the information of the port through which the slave device 22 has transmitted the search frame.

Note that, in the master device 11, the frame generating unit 251 illustrated in FIG. 2 generates a search frame, and the configuration search analyzing unit 243 illustrated in FIG. 2 analyzes a received search frame. In addition, the frame transferring unit 252 performs a process of transferring the received search frame.

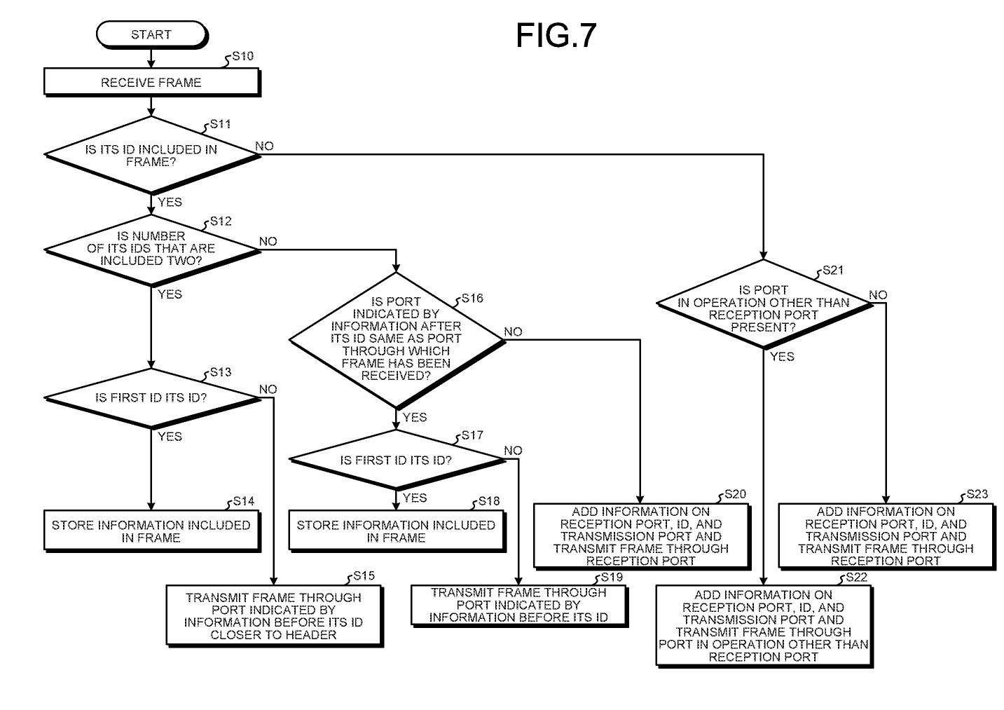

FIG. 7 is a flowchart illustrating the operation of searching for paths performed by the communication devices according to the present invention. For searching for paths, the communication devices 11, 21, 22, 23, and 24 illustrated in FIG. 3 operate according to the flowchart illustrated in FIG. 7. Specifically, each of the communication devices operates according to the flowchart illustrated in FIG. 7 regardless of whether the communication device is a master communication device or a slave communication device. In FIG. 7, a search frame is simply referred to as “frame”. Thus, a “frame” described in FIG. 7 refers to a “search frame”.

Upon receiving a search frame (step S10), the communication device checks information included in the search frame and, if an ID of the communication device is included in the search frame (step S11: Yes), checks whether or the number of IDs of the communication device that are included is two (step S12). If the number of IDs of the communication device that are included is two (step S12: Yes), the communication device checks whether or not the first ID included in the search frame is the ID of the communication device (step S13). The first ID included in the search frame refers to an ID at a position closest to the header of the search frame. In the case where the information having the structure illustrated in FIGS. 5 and 6 is included in the search frame, for example, ‘A’ corresponds to the first ID. If the first ID is the ID of the communication device (step S13: Yes), the communication device stores the information included in the received search frame (step S14). Note that the information included in the received search frame is stored by the information storage unit 234 illustrated in FIG. 2.

If the first ID is not the ID of the communication device (step S13: No), the communication device transmits the received search frame through a port indicated by information immediately before the ID of the communication device that is the closer to the header of the two IDs of the communication device included in the search frame (step S15). This process of step S15 is a process of transferring the search frame received in step S10 to the port that first received the search frame.

If the number of IDs of the communication device included in the search frame is one (step S12: No), the communication device checks whether or not the received search frame has been received through the port indicated by the information immediately after the ID of the communication device included in the search frame (step S16). In other words, the communication device checks whether or not the port indicated by the information immediately after the ID of the communication device is same as the port through which the search frame has been received. If the received search frame has been received through the port indicated by the information immediately after the ID of the communication device (step S16: Yes), the communication device checks whether or not the first ID included in the search frame is the ID of the communication device (step S17). If the first ID is the ID of the communication device (step S17: Yes), the communication device stores the information included in the received search frame (step S18).

If the first ID is not the ID of the communication device (step S17: No), the communication device transmits the received search frame through the port indicated by the information immediately before the ID of the communication device (step S19). This process of step S19 is a process of transferring the search frame received in step S10 to the port that first received the search frame, similarly to the process in step S15 described above.

If the received search frame has not been received through the port indicated by the information immediately after the ID of the communication device (step S16: No), the communication device adds information on the port through which the search frame has been received, the ID of the communication device, and information on the port through which the search frame is to be transmitted to the received search frame, and transmits the resulting search frame through the port that has received the search frame (step S20). This process of step S20 is a process of adding necessary information to the search frame received in step S10, and then transmitting, that is, returning the resulting search frame through the port that has received the search frame. The search frame transmitted in step S20 corresponds to a response frame in response to the search frame received in step S10. A response frame is a search frame that is relayed while following the path through which the search frame was received in the opposite direction, and finally reaches the communication device that initially transmitted the search frame.

If the ID of the communication device is not included in the received search frame (step S11: No), the communication device checks whether or not a port in operation other than the port that has received the search frame is present (step S21). If a port in operation other than the port that has received the search frame is present (step S21: Yes), the communication device adds information on the port through which the search frame has been received, the ID of the communication device, and information on the port through which the search frame is to be transmitted to the received search frame, and transmits the resulting search frame through a port in operation other than the port that has received the search frame (step S22). In this process, if a plurality of ports in operation other than the port that has received the search frame are present, the communication device transmits the search frame through all the ports in operation (other than the port that has received the search frame).

If no port in operation other than the port that has received the search frame is present (step S21: No), the communication device adds information on the port that has received the search frame, the ID of the communication device, and information on the port through which the search frame is to be transmitted to the received search frame, and transmits the resulting search frame through the port that has received the search frame (step S23). The search frame transmitted in step S23 corresponds to a response frame in response to the search frame received in step S10.

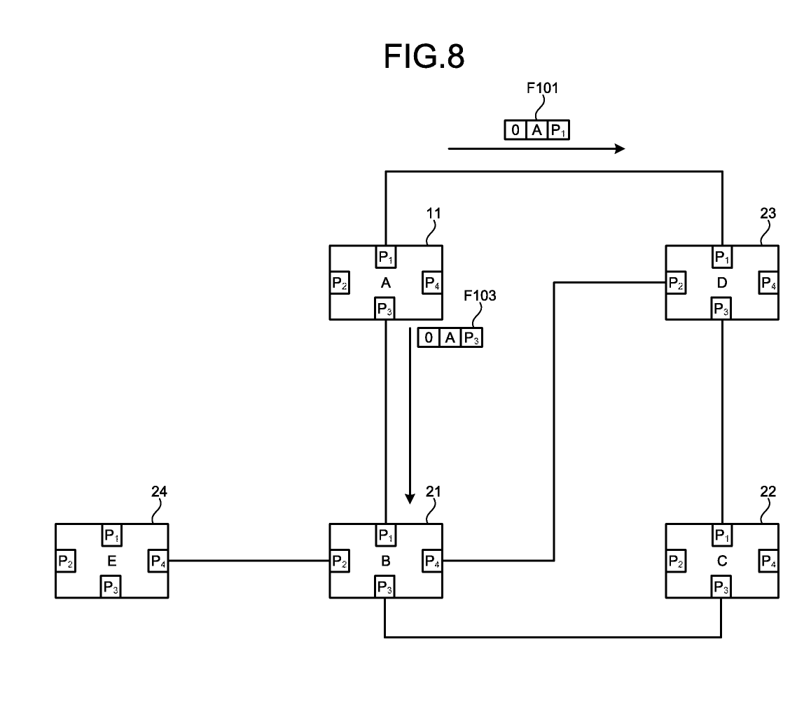

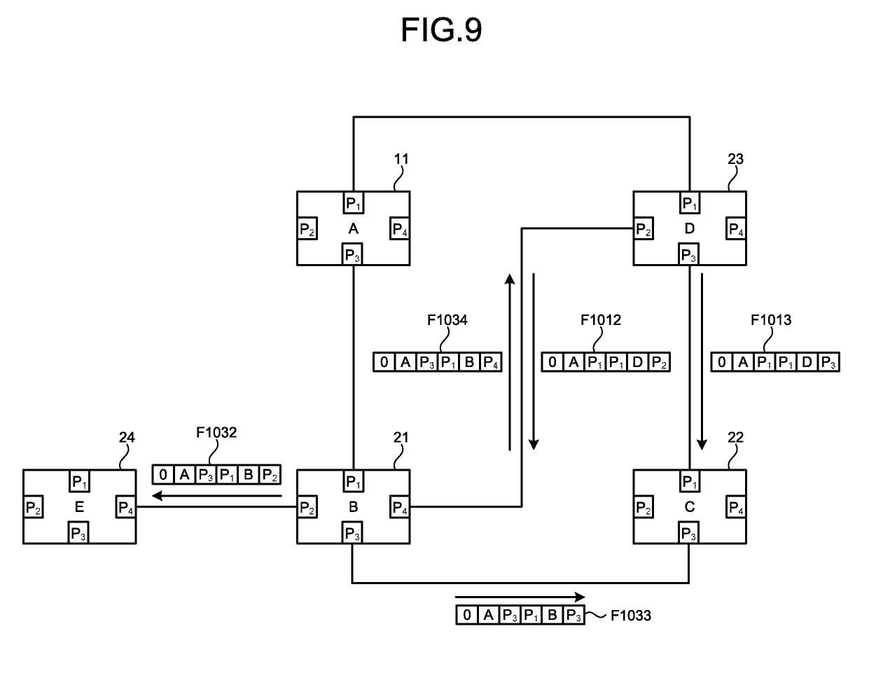

Next, a specific example of the operation of the master device 11 for searching for selectable paths will be explained. First, the master device 11 transmits a search frame, which is a frame for searching for a communication path, through respective ports in operation. Specifically, as illustrated in FIG. 8, the master device 11 transmits a search frame F101 through the port P₁ with which the slave device 23 is connected, and a search frame F103 through the port P₃ with which the slave device 21 is connected. FIG. 8 is a diagram illustrating operation of a communication device that is a source of a search frame. Note that, in FIG. 8, the headers, etc., of the search frames are not illustrated but only information included in the frames are illustrated. The same applies to the drawings of FIG. 9 and subsequent figures referred to in the description below. As explained with reference to FIG. 4, the search frame F101 includes information ‘0’, ‘A’, and ‘P₁’. Similarly, the search frame F103 includes information ‘0’, ‘A’, and ‘P₃’.

FIG. 9 is a diagram illustrating operations of communication devices that have received the search frames illustrated in FIG. 8. The slave device 23 that has received the search frame F101 and the slave device 21 that has received the search frame F103 transfer the received search frames through ports in operation other than the ports that have received the search frames as illustrated in FIG. 9. This process corresponds to the process in step S22 of the flowchart illustrated in FIG. 7.

Specifically, the slave device 23 transfers the received search frame F101 converted to a search frame F1012 through the port P₂ and converted to a search frame F1013 through the port P₃. The search frame F1012 includes information ‘P₁’ on the reception port, the identification information ‘D’ of the slave device 23, and information ‘P₂’ on the transmission port in addition to the information included in the search frame F101. The search frame F1013 includes information ‘P₁’ on the reception port, the identification information ‘D’ of the slave device 23, and information ‘P₃’ on the transmission port in addition to the information included in the search frame F101. Similarly, the slave device 21 transfers the received search frame F103 converted to a search frame F1032 through the port P₂ and converted to a search frame F1033 through the port P₃. The slave device 21 further transfers the received search frame F103 converted to a search frame F1034 through the port P₄. The search frame F1032 includes information ‘P₁’ on the reception port, the identification information ‘B’ of the slave device 21, and information ‘P₂’ on the transmission port in addition to the information included in the search frame F103. The search frame F1033 includes information ‘P₁’ on the reception port, the identification information ‘B’ of the slave device 21, and information ‘P₃’ on the transmission port in addition to the information included in the search frame F103. The search frame F1034 includes information ‘P₁’ on the reception port, the identification information ‘B’ of the slave device 21, and information ‘P₄’ on the transmission port in addition to the information included in the search frame F103.

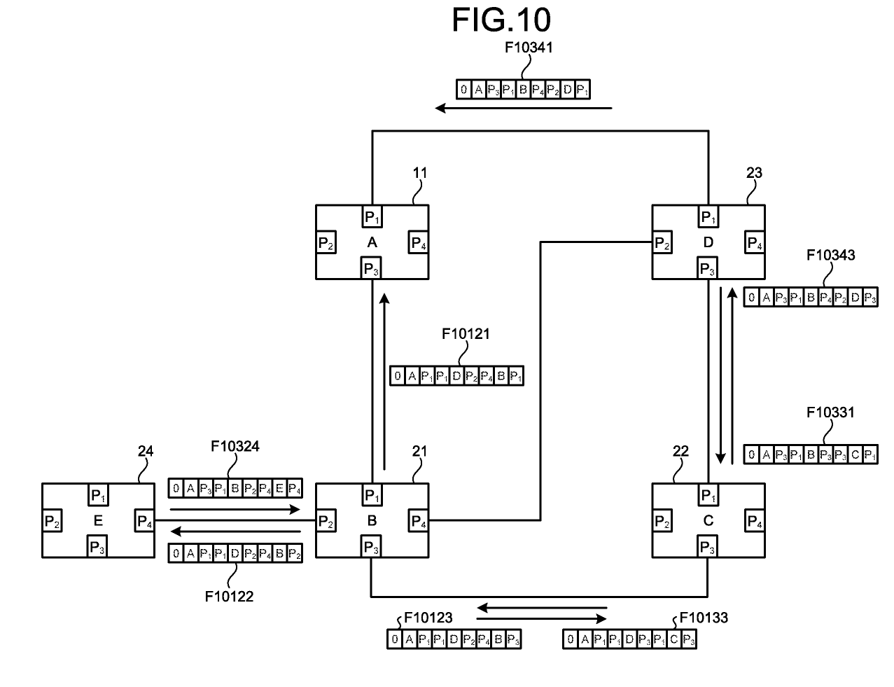

FIG. 10 is a diagram illustrating operations of communication devices that have received the search frames illustrated in FIG. 9.

According to the operations illustrated in FIG. 10, the slave devices 21, 22, and 23 perform operations similar to those illustrated in FIG. 9, that is, operations corresponding to the process in step S22 of the flowchart illustrated in FIG. 7 to transfer the search frames. Specifically, the slave device 21 converts the search frame F1012 received through the port P₄ to search frames F10121, F10122, and F10123, and transfers the search frames F10121, F10122, and F10123 through the ports P₁, P₂, and P₃, respectively. The slave device 22 transfers the search frame F1013 received through the port P₁ and converted to a search frame F10133 through the port P₃, and the search frame F1033 received through the port P₃ and converted to a search frame F10331 through the port P₁. The slave device 23 converts the search frame F1034 received through the port P₂ to search frames F10341 and F10343, and transfers the search frames F10341 and F10343 through the ports P₁ and P₃, respectively. The search frames transferred by the slave devices 21, 22, and 23 include information on the reception port, the identification information of the communication device, and information on the transmission port in addition to the information included in the received search frames.

The search frame F10341 transferred by the slave device 23 is received by the master device 11. Upon receiving the search frame F10341, in which the first ID is the ID of the master device 11, the master device 11 stores information ‘0’, ‘A’, ‘P₃’, ‘P₁’, ‘B’, ‘P₄’, ‘P₂’, ‘D’, and ‘P₁’ included in the search frame F10341. This process corresponds to the process in step S18 of the flowchart illustrated in FIG. 7.

In the meantime, the slave device 24 has no port in operation other than the port that has received the search frame F1032. The slave device 24 thus transfers the search frame F1032 converted to a search frame F10324 to the port P₄ that has received the search frame F1032. In this case as well, the slave device 24 adds information on the reception port, the identification information of the slave device 24, and information on the transmission port to the search frame F1032, and then transfers the resulting search frame F10324. Specifically, the slave device 24 adds information ‘P₄’ on the reception port, the identification information ‘E’ of the slave device 24, and information ‘P₄’ on the transmission port to the search frame F1032, and transfers the resulting search frame F10324. The process performed by the slave device 24 illustrated in FIG. 10 corresponds to the process in step S23 of the flowchart illustrated in FIG. 7.

The search frame F10324 transmitted by the slave device 24 is received by the slave device 21. Upon receiving the search frame F10324, in which one ID ‘B’ of the slave device 21 is included and the information on the transmission port immediately after the ID of the slave device 21 is ‘P₂’ indicating the same port as the port P₂ that has received the search frame F10324, the slave device 21 transmits the search frame F10324 through the port indicated by the reception port information ‘P₁’ immediately before the ID of the slave device 21. In this process, the slave device 21 transmits the received search frame F10324 without adding any information thereto. This process corresponds to the process in step S19 of the flowchart illustrated in FIG. 7. As a result, the search frame F10324 transmitted by the slave device 21 reaches the master device 11. The master device 11 receives the search frame F10324 through the port P₃, and checks the information included therein. The master device 11 recognizes that one ID ‘A’ of the master device 11 is included in the search frame F10324 and that the first ID is the ID of the master device 11. In addition, since the reception port information immediately after the ID of the master device 11 is ‘P₃’, which indicates the port P₃ that has received the search frame F10324, the master device 11 stores the information ‘0’, ‘A’, ‘P₃’, ‘P₁’, ‘B’, ‘P₂’, ‘P₄’, ‘E’, and ‘P₄’ included in the search frame F10324. This process corresponds to the process in step S18 of the flowchart illustrated in FIG. 7.

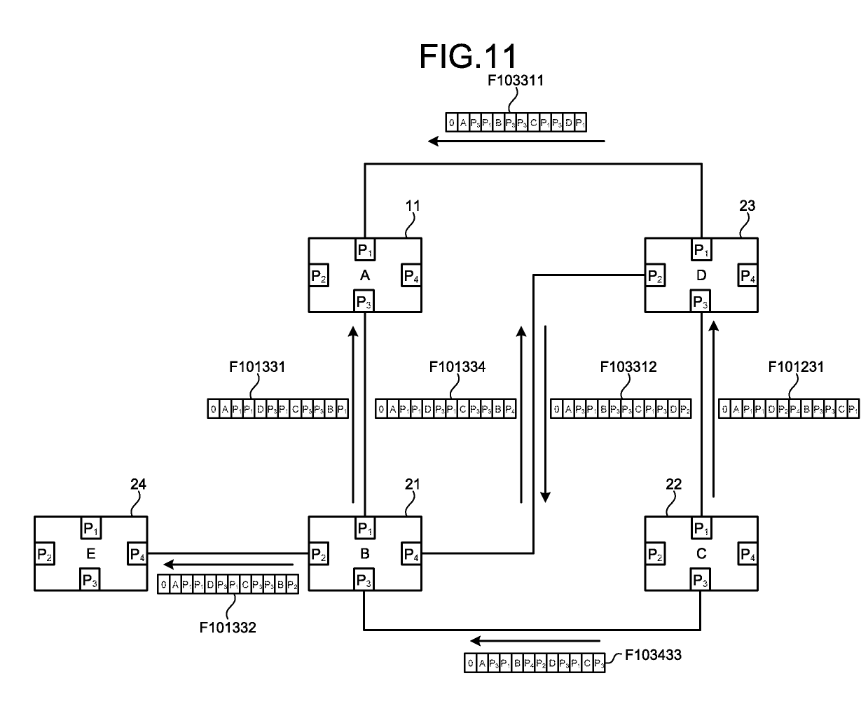

FIG. 11 is a first figure illustrating operations of communication devices that have received the search frames illustrated in FIG. 10. FIG. 11 illustrates the operations of the communication devices that have received the search frames F10123, F10133, F10331, and F10343 among the search frames illustrated in FIG. 10.

As illustrated in FIG. 10, the search frame F10133 is received by the slave device 21, and the search frame F10331 is received by the slave device 23. The search frames F10123 and F10343 are received by the slave device 22.

The slave devices 21, 22, and 23 each check information included in the received search frame, and determine that its ID is not included in the received search frame. The slave devices 21, 22, and 23 each have a port or ports in operation other than the port that has received the search frame. Thus, the slave devices 21, 22, and 23 each add information on the reception port, its identification information, and information on the transmission port to the received search frame, and transmits the resulting search frame through a port or ports in operation other than the port that has received the search frame.

Specifically, the slave device 21 converts the search frame F10133 received through the port P₃ to search frames F101331, F101332, and F101334, and transfers the search frames F101331, F101332, and F101334 through the ports P₁, P₂, and P₄, respectively. The slave device 22 transfers the search frame F10343 received through the port P₁ and converted to a search frame F103433 through the port P₃, and the search frame F10123 received through the port P₃ and converted to a search frame F101231 through the port P₁. The slave device 23 converts the search frame F10331 received through the port P₃ to search frames F103311 and F103312, and transfers the search frames F103311 and F103312 through the ports P₁ and P₂, respectively.

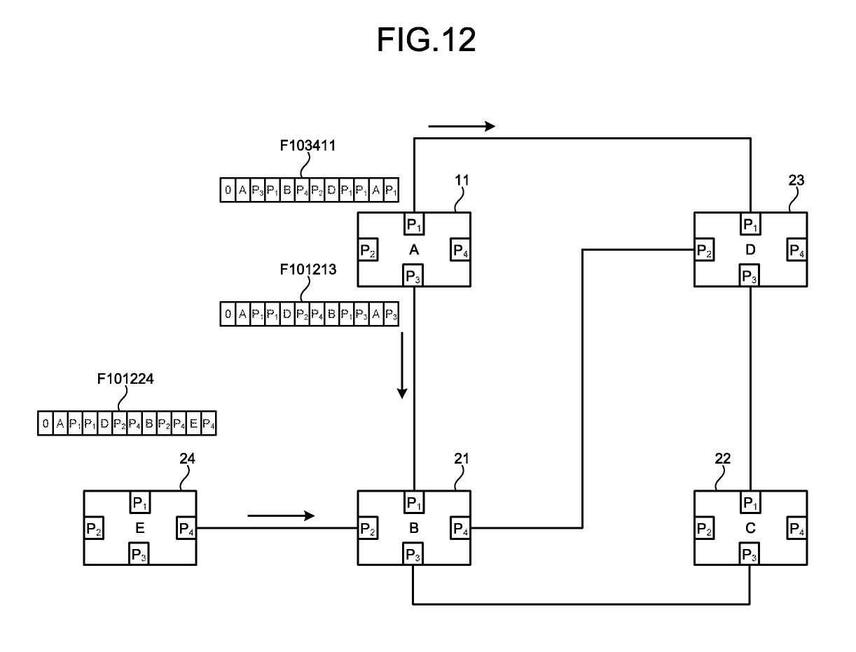

FIG. 12 is a second figure illustrating operations of the communication devices that have received the search frames illustrated in FIG. 10. FIG. 12 illustrates the operations of the communication devices that have received the search frames F10121, F10122, and F10341 among the search frames illustrated in FIG. 10.

As illustrated in FIG. 10, the search frames F10121 and F10341 are received by the master device 11. The search frame F10122 is received by the slave device 24.

Upon receiving the search frame F10341 illustrated in FIG. 10, the master device 11 checks the information included therein. In the search frame F10341, one ID ‘A’ of the master device 11 is included, and information on the transmission port immediately after the ID is ‘P₃’, which indicates a port different from the port P₁ that has received the search frame F10341. Thus, the master device 11 adds the information on the reception port, the identification information of the master device 11, and the information on the transmission port to the search frame F10341, and transmits the resulting search frame F103411 through the port P₁. This process corresponds to the process in step S20 of the flowchart illustrated in FIG. 7.

The search frame F103411 transmitted by the master device 11 is received by the slave device 23. Upon receiving the search frame F103411, the slave device 23 checks that one ID ‘D’ of the slave device 23 is included and that the information on the transmission port immediately after the ID of the slave device 23 is ‘P₁’, which indicates the port P₁ that has received the search frame F103411. Thus, the slave device 23 transmits the search frame F103411 through the port indicated by the reception port information ‘P₂’ immediately before the ID ‘D’ of the slave device 23. In this process, the slave device 23 transmits the received search frame F103411 without adding any information thereto. This process corresponds to the process in step S19 of the flowchart illustrated in FIG. 7.

The search frame F103411 transmitted by the slave device 23 is received by the slave device 21. In the search frame F103411, one ID ‘B’ of the slave device 21 is included, and information on the transmission port immediately after the ID of the slave device 21 is ‘P₄’, which indicates the port P₄ through which the slave device 21 has received the search frame F103411. Thus, the slave device 21 performs a process similar to that of the slave device 23, to transmit the search frame F103411 through the port indicated by the reception port information ‘P₁’ immediately before the ID ‘B’ of the slave device 21.

The search frame F103411 transmitted by the slave device 21 is received by the master device 11. The master device 11 receives the search frame F103411 through the port P₃, and checks the information included therein. Since the search frame F103411 includes two IDs ‘A’ of the master device 11 and the first ID in the search frame F103411 is the ID of the master device 11, the master device 11 stores the information ‘0’, ‘A’, ‘P₃’, ‘P₁’, ‘B’, ‘P₄’, ‘P₂’, ‘D’, ‘P₁’, ‘P’, ‘A’, and ‘P₁’ included in the search frame F103411. This process corresponds to the process in step S14 of the flowchart illustrated in FIG. 7.

Note that the operation when the master device 11 has received the search frame F10121 illustrated in FIG. 10 is similar to that when the master device has received the search frame F10341. Specifically, upon receiving the search frame F10121, the master device 11 checks the information included therein. In the search frame F10121, one ID ‘A’ of the master device 11 is included, and information on the transmission port immediately after the ID is ‘P₁’, which indicates a port different from the port P₃ that has received the search frame F10121. Thus, similarly to the operation when the search frame F10341 has been received, the master device 11 adds the information on the reception port, the identification information of the master device 11, and the information on the transmission port to the search frame F10121, and transmits the resulting search frame F101213 through the port P₃. The search frame F101213 passes through the slave device 21 and the slave device 23, and finally reaches the master device 11. Upon receiving the search frame F101213, similarly to when receiving the search frame F103411, the master device 11 stores the information included in the search frame F101213.

In addition, upon receiving the search frame F10122 illustrated in FIG. 10, the slave device 24 checks the information included therein. The search frame F10122 does not include the ID ‘E’ of the slave device 24. In addition, the slave device 24 has no port in operation other than the port P₄ that has received the search frame F10122. Thus, the slave device 24 adds information on the reception port, the identification information of the slave device 24, and information on the transmission port to the search frame F10122, and transmits the resulting search frame F101224 through the port P₄ that has received the search frame F10122. This process corresponds to the process in step S23 of the flowchart illustrated in FIG. 7.

The search frame F101224 transmitted by the slave device 24 is received by the slave device 21. Upon receiving the search frame F101224, the slave device 21 checks that one ID ‘B’ of the slave device 21 is included and that the information on the transmission port immediately after the ID of the slave device 21 is ‘P₂’, which indicates the port P₂ that has received the search frame F101224. Thus, the slave device 21 transmits the search frame F101224 through the port indicated by the reception port information ‘P₄’ immediately before the ID ‘B’ of the slave device 21. In this process, the slave device 21 transmits the received search frame F101224 without adding any information thereto.

The search frame F101224 transmitted by the slave device 21 is received by the slave device 23. Upon receiving the search frame F101224, the slave device 23 checks that one ID ‘D’ of the slave device 23 is included and that the information on the transmission port immediately after the ID of the slave device 23 is ‘P₂’, which indicates the port P₂ that has received the search frame F101224. Thus, the slave device 23 performs a process similar to that of the slave device 21, to transmit the search frame F101224 through the port indicated by the reception port information ‘P₁’ immediately before the ID ‘D’ of the slave device 23.

The search frame F101224 transmitted by the slave device 23 is received by the master device 11. Upon receiving the search frame F101224, the master device 11 checks the information included therein. In the search frame F101224, one ID ‘A’ of the master device 11 is included, and information on the transmission port immediately after the ID of the master device 11 is ‘P₁’, which indicates the port P₁ through which the master device 11 has received the search frame F101224. Furthermore, the first ID included in the search frame F101224 is the ID of the master device 11. Thus, the master device 11 stores the information included in the received search frame F101224. This process corresponds to the process in step S18 of the flowchart illustrated in FIG. 7.

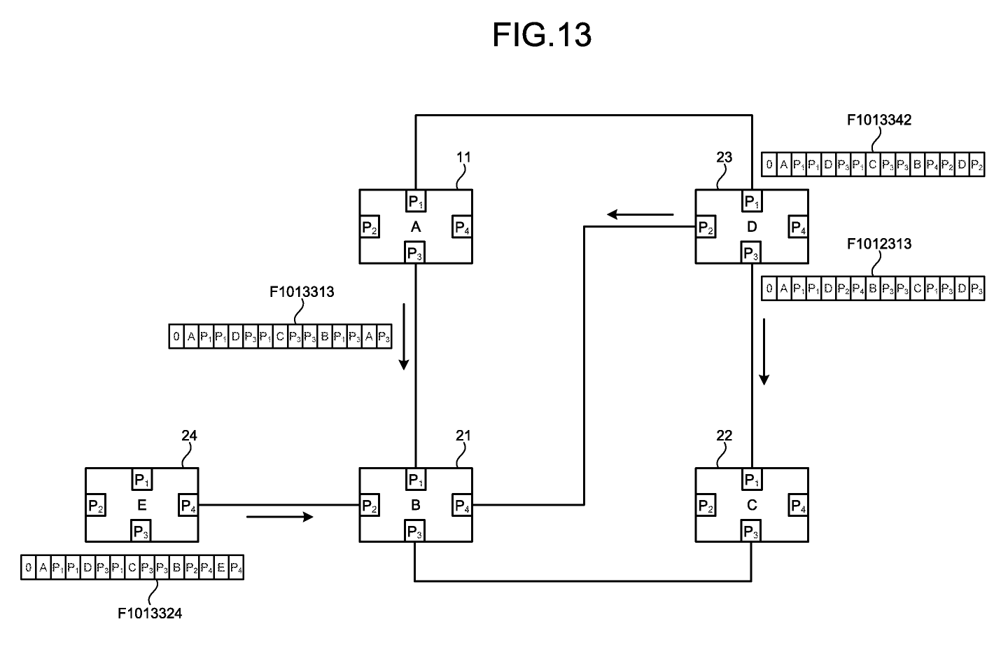

FIG. 13 is a first figure illustrating operations of communication devices that have received the search frames illustrated in FIG. 11. FIG. 13 illustrates the operations of the communication devices that have received the search frames F101331, F101332, F101334, and F101231 among the search frames illustrated in FIG. 11.

As illustrated in FIG. 11, the search frame F101331 is received by the master device 11. The search frame F101332 is received by the slave device 24, and the search frames F101334 and F101231 are received by the slave device 23.

Upon receiving the search frame F101331, the master device 11 checks the information included therein. In the search frame F101331, one ID ‘A’ of the master device 11 is included, and information on the transmission port immediately after the ID is ‘P₁’, which indicates a port different from the port P₃ that has received the search frame F101331. Thus, the master device 11 adds information on the reception port, the identification information of the master device 11, and information on the transmission port to the search frame F101331, and transmits the resulting search frame F1013313 through the port P₃ that has received the search frame F101331. This process corresponds to the process in step S20 of the flowchart illustrated in FIG. 7.

The search frame F1013313 transmitted by the master device 11 is received by the slave device 21. Upon receiving the search frame F1013313, the slave device 21 checks that one ID ‘B’ of the slave device 21 is included and that the information on the transmission port immediately after the ID of the slave device 21 is ‘P₁’, which indicates the port P₁ that has received the search frame F1013313. Thus, the slave device 21 transmits the search frame F1013313 through the port indicated by the reception port information ‘P₃’ immediately before the ID ‘B’ of the slave device 21. In this process, the slave device 21 transmits the received search frame F1013313 without adding any information thereto.

The search frame F1013313 transmitted by the slave device 21 is received by the slave device 22. In the search frame F1013313, one ID ‘C’ of the slave device 22 is included, and information on the transmission port immediately after the ID of the slave device 22 is ‘P₃’, which indicates the port P₃ through which the slave device 22 has received the search frame F1013313. Thus, the slave device 22 performs a process similar to that of the slave device 21, to transmit the search frame F1013313 through the port indicated by the reception port information ‘P₁’ immediately before the ID ‘C’ of the slave device 22.

The search frame F1013313 transmitted by the slave device 22 is received by the slave device 23. In the search frame F1013313, one ID ‘D’ of the slave device 23 is included, and information on the transmission port immediately after the ID of the slave device 23 is ‘P₃’, which indicates the port P₃ through which the slave device 23 has received the search frame F1013313. Thus, the slave device 23 performs a process similar to those of the slave devices 21 and 22, to transmit the search frame F1013313 through the port indicated by the reception port information ‘P₁’ immediately before the ID ‘D’ of the slave device 23.

The search frame F1013313 transmitted by the slave device 23 is received by the master device 11. Upon receiving the search frame F1013313, in which two IDs ‘A’ of the master device 11 are included and the first ID is the ID of the master device 11, the master device 11 stores the information included in the search frame F1013313.

In addition, upon receiving the search frame F101332, the slave device 24 checks the information included therein. The search frame F101332 does not include the ID ‘E’ of the slave device 24. In addition, the slave device 24 has no port in operation other than the port P₄ that has received the search frame F101332. Thus, the slave device 24 adds information on the reception port, the identification information of the slave device 24, and information on the transmission port to the search frame F101332, and transmits the resulting search frame F1013324 through the port P₄ that has received the search frame F101332. This process corresponds to the process in step S23 of the flowchart illustrated in FIG. 7.

The search frame F1013324 transmitted by the slave device 24 is received by the slave device 21. Upon receiving the search frame F1013324, the slave device 21 checks that one ID ‘B’ of the slave device 21 is included and that the information on the transmission port immediately after the ID of the slave device 21 is ‘P₂’, which indicates the port P₂ that has received the search frame F1013324. Thus, the slave device 21 transmits the search frame F1013324 through the port indicated by the reception port information ‘P₃’ immediately before the ID ‘B’ of the slave device 21. In this process, the slave device 21 transmits the received search frame F1013324 without adding any information thereto.

The search frame F1013324 transmitted by the slave device 21 is received by the slave device 22. Upon receiving the search frame F1013324, the slave device 22 checks that one ID ‘C’ of the slave device 22 is included and that the information on the transmission port immediately after the ID of the slave device 22 is ‘P₃’, which indicates the port P₃ that has received the search frame F1013324. Thus, the slave device 22 performs a process similar to that of the slave device 21, to transmit the search frame F1013324 through the port indicated by the reception port information ‘P₁’ immediately before the ID ‘C’ of the slave device 22.

The search frame F1013324 transmitted by the slave device 22 is received by the slave device 23. Upon receiving the search frame F1013324, the slave device 23 checks that one ID ‘D’ of the slave device 23 is included and that the information on the transmission port immediately after the ID of the slave device 23 is ‘P₃’, which indicates the port P₃ that has received the search frame F1013324. Thus, the slave device 23 performs a process similar to those of the slave devices 21 and 22, to transmit the search frame F1013324 through the port indicated by the reception port information ‘P₁’ immediately before the ID ‘D’ of the slave device 23.

The search frame F1013324 transmitted by the slave device 23 is received by the master device 11. Upon receiving the search frame F1013324, in which one ID ‘A’ of the master device 11 is included, the port P₁ indicated by the information immediately after the ID of the master device 11 is the reception port, and the first ID is the ID of the master device 11, the master device 11 stores the information included in the search frame F1013324.

In addition, upon receiving the search frame F101334, the slave device 23 checks the information included therein. In the search frame F101334, one ID ‘D’ of the slave device 23 is included, and information on the transmission port immediately after the ID is ‘P₃’, which indicates a port different from the port P₂ that has received the search frame F101334. Thus, the slave device 23 adds information on the reception port, the identification information of the slave device 23, and information on the transmission port to the search frame F101334, and transmits the resulting search frame F1013342 through the port P₂ that has received the search frame F101334. This process corresponds to the process in step S20 of the flowchart illustrated in FIG. 7.

The search frame F1013342 transmitted by the slave device 23 is received by the slave device 21. Upon receiving the search frame F1013342, the slave device 21 checks that one ID ‘B’ of the slave device 21 is included and that the information on the transmission port immediately after the ID of the slave device 21 is ‘P₄’, which indicates the port P₄ that has received the search frame F1013342. Thus, the slave device 21 transmits the received search frame F1013342 through the port indicated by the reception port information ‘P₃’ immediately before the ID ‘B’ of the slave device 21. In this process, the slave device 21 transmits the received search frame F1013342 without adding any information thereto.

The search frame F1013342 transmitted by the slave device 21 is received by the slave device 22. Upon receiving the search frame F1013342, the slave device 22 checks that one ID ‘C’ of the slave device 22 is included and that the information on the transmission port immediately after the ID of the slave device 22 is ‘P₃’, which indicates the port P₃ that has received the search frame F1013342. Thus, the slave device 22 performs a process similar to that of the slave device 21, to transmit the search frame F1013342 through the port indicated by the reception port information ‘P₁’ immediately before the ID ‘C’ of the slave device 22.

The search frame F1013342 transmitted by the slave device 22 is received by the slave device 23. Upon receiving the search frame F1013342, the slave device 23 checks that two IDs ‘D’ of the slave device 23 are included and that the first ID is not the ID of the slave device 23. Thus, the slave device 23 transmits the received search frame F1013342 through the port indicated by the reception port information ‘P₁’ immediately before the ID ‘D’ of the slave device 23 that is closer to the header. In this process, the slave device 23 transmits the search frame F1013342 without adding any information thereto. This process corresponds to the process in step S15 of the flowchart illustrated in FIG. 7.

The search frame F1013342 transmitted by the slave device 23 is received by the master device 11. Upon receiving the search frame F1013342, in which one ID ‘A’ of the master device 11 is included, the port P₁ indicated by the information immediately after the ID of the master device 11 is the reception port, and the first ID is the ID of the master device 11, the master device 11 stores the information included in the search frame F1013342.

In addition, upon receiving the search frame F101231, the slave device 23 performs a process similar to that when the search frame F101334 has been received. Specifically, the slave device 23 checks the information included in the search frame F101231. In the search frame F101231, one ID ‘D’ of the slave device 23 is included, and information on the transmission port immediately after the ID is ‘P₂’, which indicates a port different from the port P₃ that has received the search frame F101231. Thus, the slave device 23 adds information on the reception port, the identification information of the slave device 23, and information on the transmission port to the search frame F101231, and transmits the resulting search frame F1012313 through the port P₃ that has received the search frame F101231.

The search frame F1012313 transmitted by the slave device 23 is received by the slave device 22. Upon receiving the search frame F1012313, the slave device 22 checks that one ID ‘C’ of the slave device 22 is included and that the information on the transmission port immediately after the ID of the slave device 22 is ‘P₁’, which indicates the port P₁ that has received the search frame F1012313. Thus, the slave device 22 transmits the received search frame F1012313 through the port indicated by the reception port information ‘P₃’ immediately before the ID ‘C’ of the slave device 22. In this process, the slave device 22 transmits the received search frame F1012313 without adding any information thereto.

The search frame F1012313 transmitted by the slave device 22 is received by the slave device 21. Upon receiving the search frame F1012313, the slave device 21 checks that one ID ‘B’ of the slave device 21 is included and that the information on the transmission port immediately after the ID of the slave device 21 is ‘P₃’, which indicates the port P₃ that has received the search frame F1012313. Thus, the slave device 21 performs a process similar to that of the slave device 22, to transmit the search frame F1012313 through the port indicated by the reception port information ‘P₄’ immediately before the ID ‘B’ of the slave device 21.

The search frame F1012313 transmitted by the slave device 21 is received by the slave device 23. Upon receiving the search frame F1012313, the slave device 23 checks that two IDs ‘D’ of the slave device 23 are included and that the first ID is not the ID of the slave device 23. Thus, the slave device 23 transmits the received search frame F1012313 through the port indicated by the reception port information ‘P₁’ immediately before the ID ‘D’ of the slave device 23 that is closer to the header. In this process, the slave device 23 transmits the search frame F1012313 without adding any information thereto.

The search frame F1012313 transmitted by the slave device 23 is received by the master device 11. Upon receiving the search frame F1012313, in which one ID ‘A’ of the master device 11 is included, the port P₁ indicated by the information immediately after the ID of the master device 11 is the reception port, and the first ID is the ID of the master device 11, the master device 11 stores the information included in the search frame F1012313.

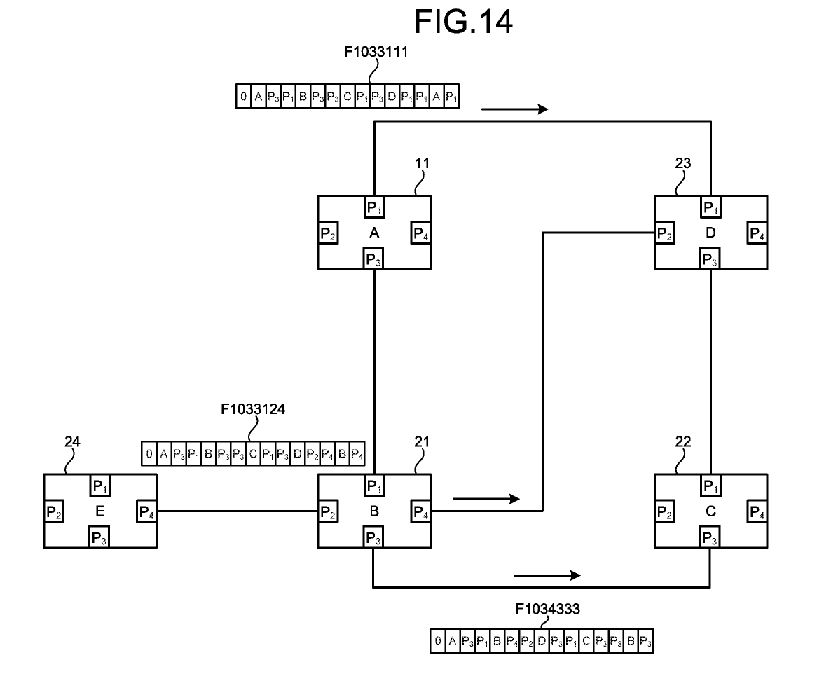

FIG. 14 is a second figure illustrating operations of the communication devices that have received the search frames illustrated in FIG. 11. FIG. 14 illustrates the operations of the communication devices that have received the search frames F103311, F103312, and F103433 among the search frames illustrated in FIG. 11.

As illustrated in FIG. 11, the search frame F103311 is received by the master device 11. The search frames F103312 and F103433 are received by the slave device 21.

Upon receiving the search frame F103311, the master device 11 checks the information included therein. In the search frame F103311, one ID ‘A’ of the master device 11 is included, and information on the transmission port immediately after the ID is ‘P₃’, which indicates a port different from the port P₁ that has received the search frame F103311. Thus, the master device 11 adds information on the reception port, the identification information of the master device 11, and information on the transmission port to the search frame F103311, and transmits the resulting search frame F1033111 through the port P₁ that has received the search frame F103311.

The search frame F1033111 transmitted by the master device 11 is received by the slave device 23. Upon receiving the search frame F1033111, the slave device 23 checks that one ID ‘D’ of the slave device 23 is included and that the information on the transmission port immediately after the ID of the slave device 23 is ‘P₁’, which indicates the port P₁ that has received the search frame F1033111. Thus, the slave device 23 transmits the received search frame F1033111 through the port indicated by the reception port information ‘P₃’ immediately before the ID ‘D’ of the slave device 23. In this process, the slave device 23 transmits the received search frame F1033111 without adding any information thereto.

The search frame F1033111 transmitted by the slave device 23 is received by the slave device 22. In the search frame F1033111, one ID ‘C’ of the slave device 22 is included, and information on the transmission port immediately after the ID of the slave device 22 is ‘P₁’, which indicates the port P₁ through which the slave device 22 has received the search frame F1033111. Thus, the slave device 22 performs a process similar to that of the slave device 23, to transmit the search frame F1033111 through the port indicated by the reception port information ‘P₃’ immediately before the ID ‘C’ of the slave device 22.

The search frame F1033111 transmitted by the slave device 22 is received by the slave device 21. In the search frame F1033111, one ID ‘B’ of the slave device 21 is included, and information on the transmission port immediately after the ID of the slave device 21 is ‘P₃’, which indicates the port P₃ through which the slave device 21 has received the search frame F1033111. Thus, the slave device 21 performs a process similar to those of the slave devices 23 and 22, to transmit the search frame F1033111 through the port indicated by the reception port information ‘P₁’ immediately before the ID ‘B’ of the slave device 21.

The search frame F1033111 transmitted by the slave device 21 is received by the master device 11. Upon receiving the search frame F1033111, in which two IDs ‘A’ of the master device 11 are included and the first ID is the ID of the master device 11, the master device 11 stores the information included in the search frame F1033111.

In addition, upon receiving the search frame F103312, the slave device 21 checks the information included therein. In the search frame F103312, one ID ‘B’ of the slave device 21 is included, and information on the transmission port immediately after the ID is ‘P₃’, which indicates a port different from the port P₄ that has received the search frame F103312. Thus, the slave device 21 adds information on the reception port, the identification information of the slave device 21, and information on the transmission port to the search frame F103312, and transmits the resulting search frame F1033124 through the port P₄ that has received the search frame F103312. This process corresponds to the process in step S20 of the flowchart illustrated in FIG. 7.

The search frame F1033124 transmitted by the slave device 21 is received by the slave device 23. Upon receiving the search frame F1033124, the slave device 23 checks that one ID ‘D’ of the slave device 23 is included and that the information on the transmission port immediately after the ID of the slave device 23 is ‘P₂’, which indicates the port P₂ that has received the search frame F1033124. Thus, the slave device 23 transmits the received search frame F1033124 through the port indicated by the reception port information ‘P₃’ immediately before the ID ‘D’ of the slave device 23. In this process, the slave device 23 transmits the received search frame F1033124 without adding any information thereto.

The search frame F1033124 transmitted by the slave device 23 is received by the slave device 22. Upon receiving the search frame F1033124, the slave device 22 checks that one ID ‘C’ of the slave device 22 is included and that the information on the transmission port immediately after the ID of the slave device 22 is ‘P₁’, which indicates the port P₁ that has received the search frame F1033124. Thus, the slave device 22 performs a process similar to that of the slave device 23, to transmit the search frame F1033124 through the port indicated by the reception port information ‘P₃’ immediately before the ID ‘C’ of the slave device 22.

The search frame F1033124 transmitted by the slave device 23 is received by the slave device 21. Upon receiving the search frame F1033124, the slave device 21 checks that two IDs ‘B’ of the slave device 21 are included and that the first ID is not the ID of the slave device 21. Thus, the slave device 21 transmits the received search frame F1033124 through the port indicated by the reception port information ‘P₁’ immediately before the ID ‘B’ of the slave device 21 that is closer to the header. In this process, the slave device 21 transmits the search frame F1033124 without adding any information thereto.

The search frame F1033124 transmitted by the slave device 21 is received by the master device 11. Upon receiving the search frame F1033124, in which one ID ‘A’ of the master device 11 is included, the port P₃ indicated by the information immediately after the ID of the master device 11 is the reception port, and the first ID is the ID of the master device 11, the master device 11 stores the information included in the search frame F1033124.

In addition, upon receiving the search frame F103433, the slave device 21 performs a process similar to that when the search frame F103312 has been received. Specifically, the slave device 21 checks the information included in the search frame F103433. In the search frame F103433, one ID ‘B’ of the slave device 21 is included, and information on the transmission port immediately after the ID is ‘P₄’, which indicates a port different from the port P₃ that has received the search frame F103433. Thus, the slave device 21 adds information on the reception port, the identification information of the slave device 21, and information on the transmission port to the search frame F103433, and transmits the resulting search frame F1034333 through the port P₃ that has received the search frame F103433.

The search frame F1034333 transmitted by the slave device 21 is received by the slave device 22. Upon receiving the search frame F1034333, the slave device 22 checks that one ID ‘C’ of the slave device 22 is included and that the information on the transmission port immediately after the ID of the slave device 22 is ‘P₃’, which indicates the port P₃ that has received the search frame F1034333. Thus, the slave device 22 transmits the received search frame F1034333 through the port indicated by the reception port information ‘P₁’ immediately before the ID ‘C’ of the slave device 22. In this process, the slave device 22 transmits the received search frame F1034333 without adding any information thereto.

The search frame F1034333 transmitted by the slave device 22 is received by the slave device 23. Upon receiving the search frame F1034333, the slave device 23 checks that one ID ‘D’ of the slave device 23 is included and that the information on the transmission port immediately after the ID of the slave device 23 is ‘P₃’, which indicates the port P₃ that has received the search frame F1034333. Thus, the slave device 23 performs a process similar to that of the slave device 22, to transmit the search frame F1034333 through the port indicated by the reception port information ‘P₂’ immediately before the ID ‘D’ of the slave device 23.

The search frame F1034333 transmitted by the slave device 23 is received by the slave device 21. Upon receiving the search frame F1034333, the slave device 21 checks that two IDs ‘B’ of the slave device 21 are included and that the first ID is not the ID of the slave device 21. Thus, the slave device 21 transmits the received search frame F1034333 through the port indicated by the reception port information ‘P₁’ immediately before the ID ‘B’ of the slave device 21 that is closer to the header. In this process, the slave device 21 transmits the search frame F1034333 without adding any information thereto.

The search frame F1034333 transmitted by the slave device 21 is received by the master device 11. Upon receiving the search frame F1034333, in which one ID ‘A’ of the master device 11 is included, the port P₃ indicated by the information immediately after the ID of the master device 11 is the reception port, and the first ID is the ID of the master device 11, the master device 11 stores the information included in the search frame F1034333.

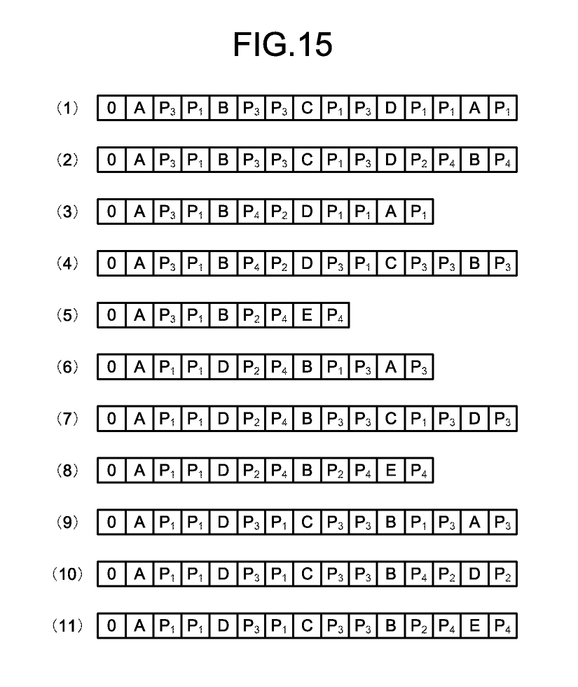

When the operations explained with reference to FIGS. 8 to 14 are completed, the path searching operation performed by the master device 11 is terminated, and the master device 11 is in a state in which the master device 11 stores the information illustrated in FIG. 15. FIG. 15 is a diagram illustrating an example of information on selectable paths, which are collected by the master device 11 through the path searching operation. Each of a series of horizontally continuous information strings (1) to (11) represents one of the selectable paths. For example, (1) “0, A, P₃, P₁, B, P₃, P₃, C, P₁, P₃, D, P₁, P₁, A, P₁” is information representing one path.

The master device 11 can identify the entire configuration of the communication network and obtain all the communication paths that can be used for communication with each of the slave devices 21 to 24, that is, all the selectable communication paths, by analyzing the information strings (1) to (11) illustrated in FIG. 15. In the master device 11, analysis of the information strings (1) to (11) illustrated in FIG. 15 is performed by the configuration search analyzing unit 243 illustrated in FIG. 2. The configuration search analyzing unit 243 is an information analyzing unit that identifies the entire configuration of the communication network. The information strings (1) to (11) illustrated in FIG. 15 indicate that two ports associated with two information items each being sandwiched by two IDs are physically connected with each other, that is, communication devices associated with two IDs on respective sides of two continuous information items representing ports are connected with each other. In addition, a case where two identical IDs are present in an information string representing one path means that a loop structure from the ID as a source is formed. In addition, a case where all the IDs included in an information string representing one path are different from one another indicates that a communication device associated with the last ID is located at the end of the path.

In a case where a path is a loop, a communication network having a logical tree structure can be formed by logically setting any of ports, which are included in the loop, of the communication device having the smallest ID or the communication device having the largest ID of all the communication devices forming the loop so that frames do not pass the port, for example.

(Path Selecting Operation)

After performing the path searching operation to collect the information strings (1) to (11) of the selectable paths illustrated in FIG. 15, the master device 11 then selects a path to be used for communication with each of the slave devices 21 to 24 from all the selectable paths. For example, the master device 11 measures transmission delay times of each of the paths, and selects a path with the shortest transmission delay time. In the master device 11, the measurement of transmission delay times is performed by the received frame analyzing unit 230 and the transmission frame generating unit 231 illustrated in FIG. 2 in cooperation with each other. For example, the frame generating unit 251 of the transmission frame generating unit 231 generates a frame for time measurement and transmits the frame to a slave device, and the synchronization accuracy analyzing unit 242 of the received frame analyzing unit 230 receives a response frame in response to the frame. The synchronization accuracy analyzing unit 242 then calculates the transmission delay time on the basis of the time at which the frame for time measurement was transmitted by the frame generating unit 251 and the time at which the response frame was received.

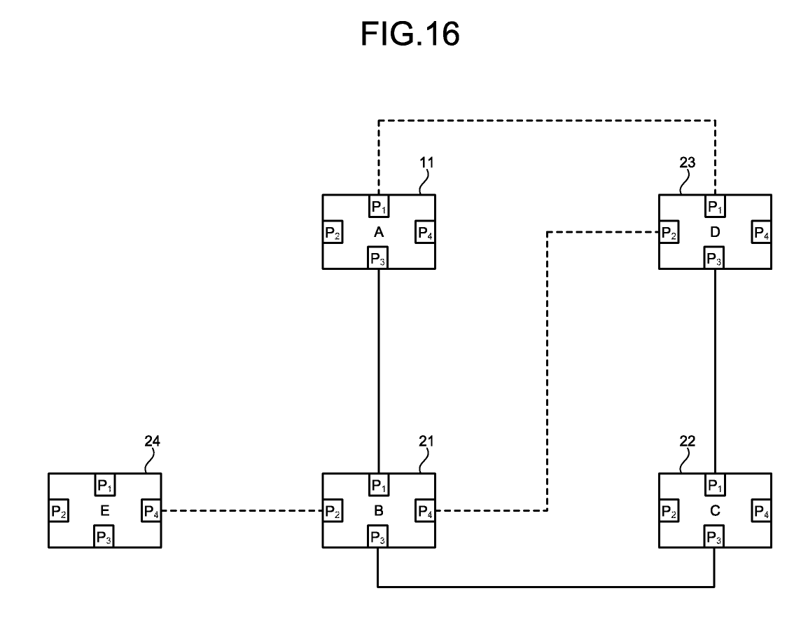

The master device 11 analyzes the information strings illustrated in FIG. 15, and first measures transmission delay times on a path shown by lines in FIG. 16, that is, specifically, a communication path passing through the slave devices 21 and 22 to the slave device 23 on the basis of the information strings (1) and (2) in FIG. 15. In this process, the master device 11 measures transmission delay times to the respective slave devices on the communication path. FIG. 16 is a diagram illustrating a first communication path on which measurement of the transmission delay times is performed. In FIG. 16, the path for measurement is shown by lines, which also applies in the drawings referred to in the description below. In the case of the communication path illustrated in FIG. 16, the master device 11 measures a transmission delay time to the slave device 21, a transmission delay time to the slave device 22, and a transmission delay time to the slave device 23. This measurement operation is referred to as first delay time measurement.

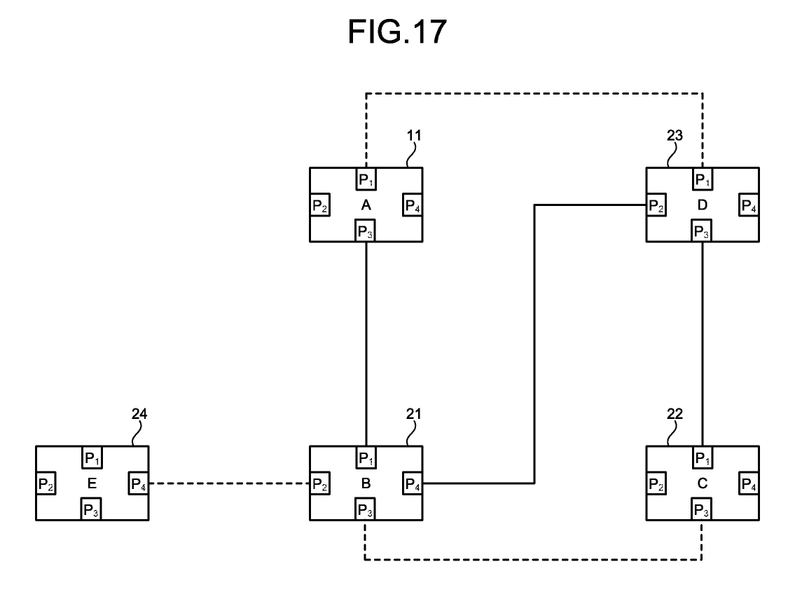

Subsequently, the master device 11 measures transmission delay times of a path illustrated in FIG. 17, that is, a communication path passing through the slave devices 21 and 23 to the slave device 22 on the basis of the information strings (3) and (4) in FIG. 15. FIG. 17 is a diagram illustrating a second communication path on which measurement of the transmission delay times is performed. In this case as well, the master device 11 measures the transmission delay times to the respective slave devices on the communication path. This measurement operation is referred to as second delay time measurement.

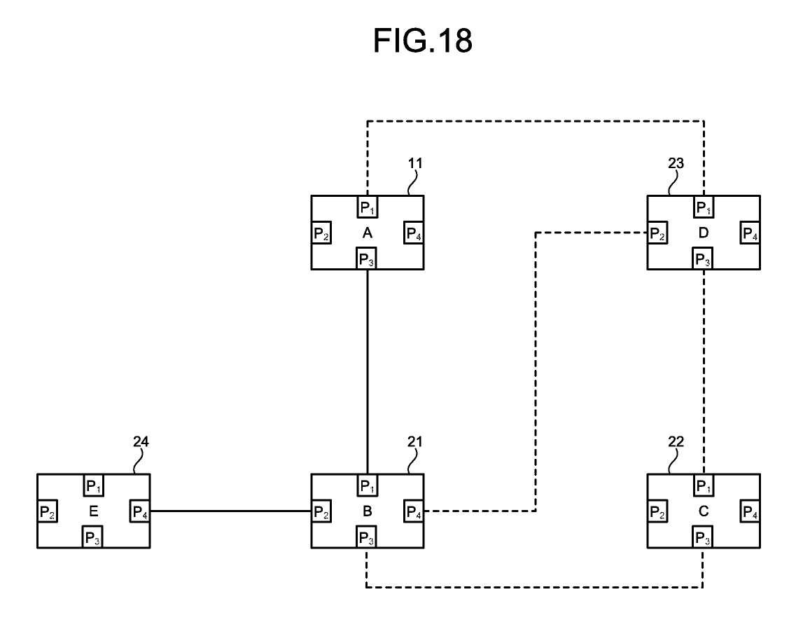

Subsequently, the master device 11 measures transmission delay times of a path illustrated in FIG. 18, that is, a communication path passing through the slave device 21 to the slave device 24 on the basis of the information string (5) in FIG. 15. FIG. 18 is a diagram illustrating a third communication path on which measurement of the transmission delay times is performed. In this case as well, the master device 11 measures the transmission delay times to the respective slave devices on the communication path. This measurement operation is referred to as third delay time measurement.

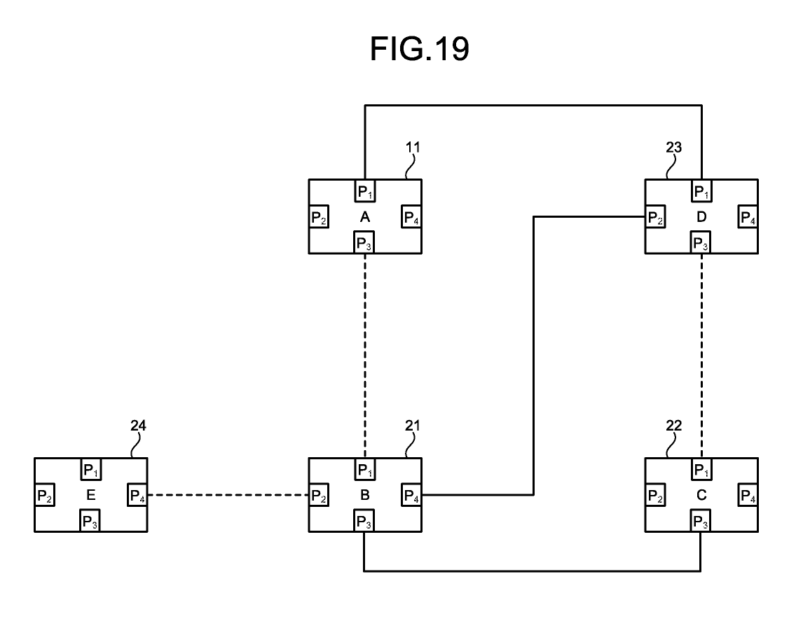

Subsequently, the master device 11 measures transmission delay times of a path illustrated in FIG. 19, that is, a communication path passing through the slave devices 23 and 21 to the slave device 22 on the basis of the information strings (6) and (7) in FIG. 15. FIG. 19 is a diagram illustrating a fourth communication path on which measurement of the transmission delay times is performed. In this case as well, the master device 11 measures the transmission delay times to the respective slave devices on the communication path. This measurement operation is referred to as fourth delay time measurement.

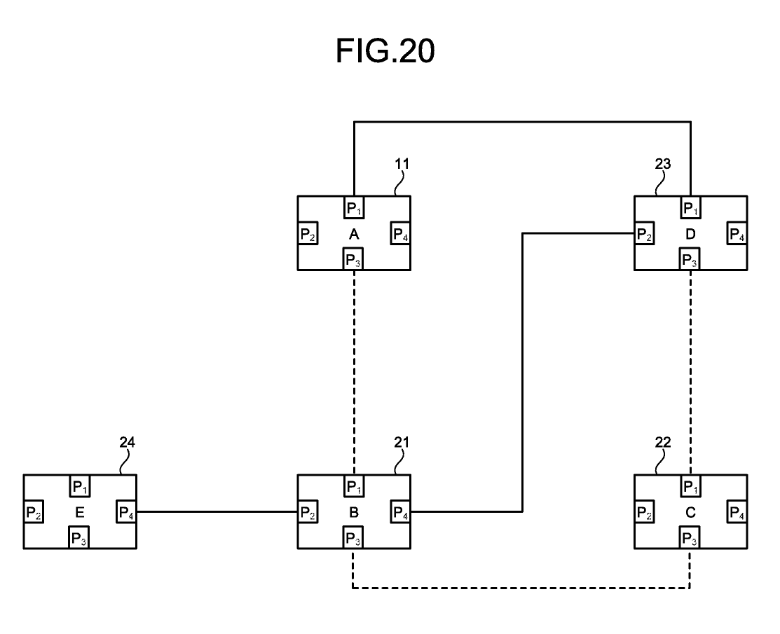

Subsequently, the master device 11 measures transmission delay times of a path illustrated in FIG. 20, that is, a communication path passing through the slave devices 23 and 21 to the slave device 24 on the basis of the information string (8) in FIG. 15. FIG. 20 is a diagram illustrating a fifth communication path on which measurement of the transmission delay times is performed. In this case as well, the master device 11 measures the transmission delay times to the respective slave devices on the communication path. This measurement operation is referred to as fifth delay time measurement.

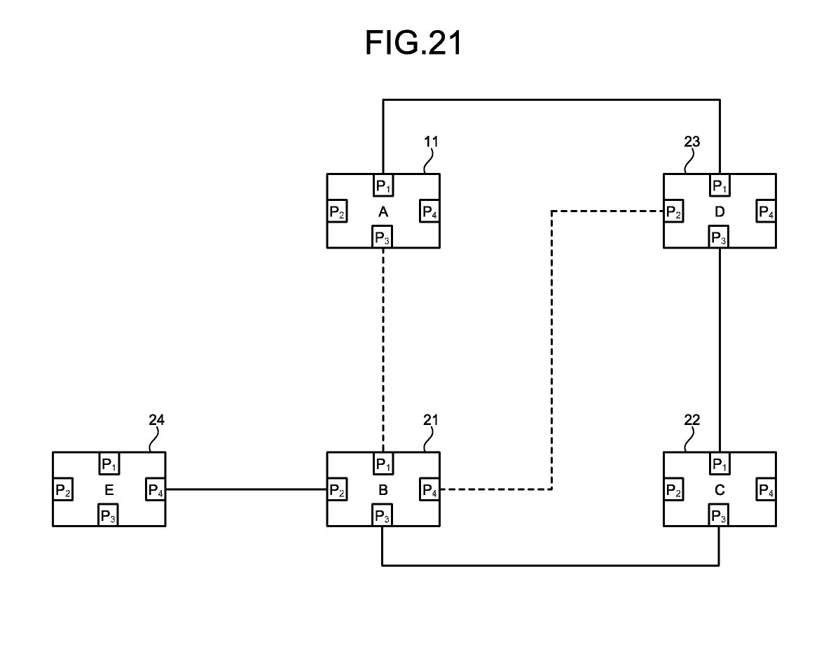

Subsequently, the master device 11 measures transmission delay times of a path illustrated in FIG. 21, that is, a communication path passing through the slave devices 23, 22 and 21 to the slave device 24 on the basis of the information strings (9) to (11) in FIG. 15. FIG. 21 is a diagram illustrating a sixth communication path on which measurement of the transmission delay times is performed. In this case as well, the master device 11 measures the transmission delay times to the respective slave devices on the communication path. This measurement operation is referred to as sixth delay time measurement.

After completing the first delay time measurement to the sixth delay time measurement described above, the master device 11 selects a communication path to each of the slave devices on the basis of the obtained measurement results. Specifically, the master device 11 selects a communication path with the shortest transmission delay time to each of the slave devices.

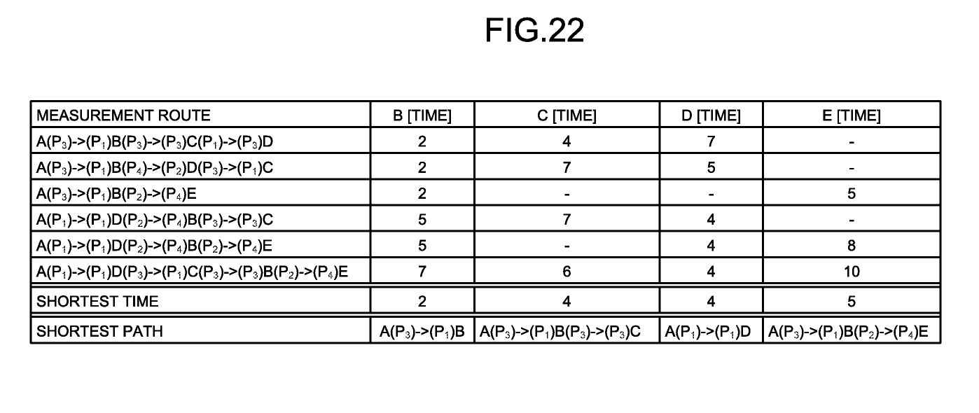

FIG. 22 is a table illustrating an example of results of measurement of transmission delay times. ‘B’ to ‘E’ stated in FIG. 22 are IDs of the slave devices 21 to 24, respectively. “B [TIME]” represents the transmission delay time to the slave device 21 with the ID ‘B’. Similarly, “C [TIME]” represents the transmission delay time to the slave device 22, “D [TIME]” represents the transmission delay time to the slave device 23, and “E [TIME]” represents the transmission delay time to the slave device 24.

In FIG. 22, a measurement result in which the measurement route is “A(P₃)→(P₁)B(P₃)→(P₃)C(P₁)→(P₃)D” is a measurement result obtained by the first delay time measurement, and a measurement result in which the measurement route is “A(P₃)→(P₁)B(P₄)→(P₂)D(P₃)→(P₁)C” is a measurement result obtained by the second delay time measurement. In addition, a measurement result in which the measurement route is “A(P₃)→(P₁)B(P₂)→(P₄)E” is a measurement result obtained by the third delay time measurement, and a measurement result in which the measurement route is “A(P₁)→(P₁)D(P₂)→(P₄) B(P₃)→(P₃) C” is a measurement result obtained by the fourth delay time measurement. A measurement result in which the measurement route is “A(P₁)→(P₁)D(P₂)→(P₄)B(P₂)→(P₄)E” is a measurement result obtained by the fifth delay time measurement, and a measurement result in which the measurement route is “A(P₁)→(P₁)D(P₃)→(P₁)C(P₃)B(P₂)→(P₄)E” is a measurement result obtained by the sixth delay time measurement.

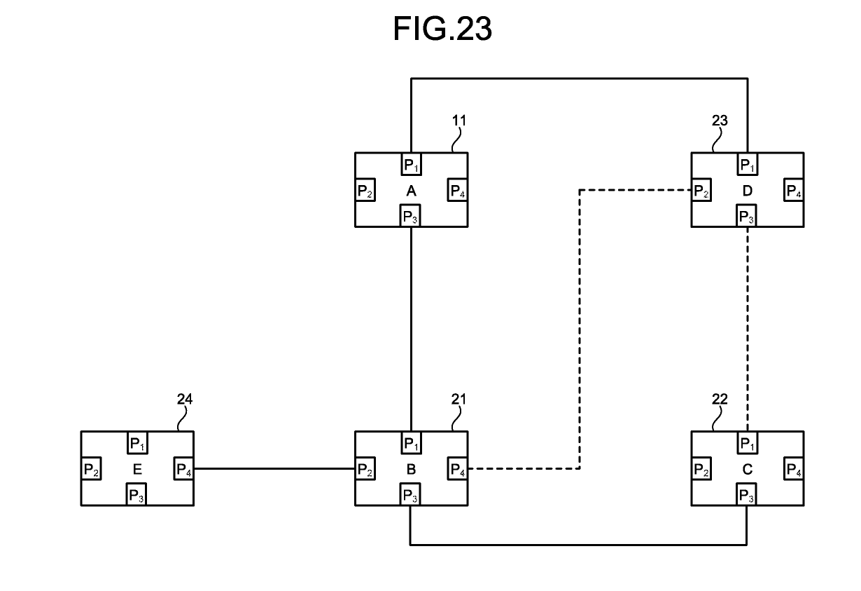

In selecting a communication path on the basis of the measurement results illustrated in FIG. 22, the master device 11 selects, as a communication path to the slave device 21, the transmission path with the transmission delay time being the smallest value 2, that is, specifically, the transmission path from the port P₃ of the master device 11 to the port P₁ of the slave device 21. In addition, the master device 11 selects, as a transmission path to the slave device 22, the transmission path with the transmission delay time being the smallest value 4, that is, specifically, the communication path from the port P₃ of the master device 11 to the port P₁ of the slave device 21 and further from the port P₃ of the slave device 21 to the port P₃ of the slave device 22. In addition, the master device 11 selects, as a communication path to the slave device 23, the communication path with the transmission delay time being the smallest value 4, that is, specifically, the communication path from the port P₁ of the master device 11 to the port P₁ of the slave device 23. In addition, the master device 11 selects, as a transmission path to the slave device 24, the transmission path with the transmission delay time being the smallest value 5, that is, specifically, the communication path from the port P₃ of the master device 11 to the port P₁ of the slave device 21 and further from the port P₂ of the slave device 21 to the port P₄ of the slave device 24. As a result, the paths illustrated in FIG. 23 are selected. In FIG. 23, solid lines show selected paths, and broken lines show unselected paths. In the master device 11 the selection of communication paths is performed by the synchronization accuracy analyzing unit 242 or the configuration search analyzing unit 243 illustrated in FIG. 2, for example. In this case, the synchronization accuracy analyzing unit 242 or the configuration search analyzing unit 243 constitutes the path selecting unit.

In addition, after selecting the communication paths, the master device 11 instructs some of the slave devices to change port setting so that communication will be performed through the selected communication paths. For example, in a case where the selected communication paths are those illustrated in FIG. 23, the master device 11 instructs at least one of the slave devices 21 and 23 to change port setting so that frames transmitted by the master device 11 will not be transmitted and received between the slave device 21 and the slave device 23. Similarly, the master device 11 instructs at least one of the slave devices 22 and 23 to change port setting so that frames transmitted by the master device 11 will not be transmitted and received between the slave device 22 and the slave device 23. The slave device in receipt of the instruction to change port setting from the master device 11 changes the port setting in accordance with the instruction.

While the operation of the master device 11 for selecting the paths for communication with the slave devices 21 to 24 has been explained above, the slave devices 21 to 24 can also select communication paths by performing similar procedures. For selecting communication paths, the slave devices 21 to 24 may transmit a search frame including information having the structure illustrated in FIG. 4 to collect information on physical connection conditions of the respective communication devices.

In addition, while the master device 11 selects a communication path with the shortest transmission delay time from the selectable communication paths in the embodiment, the selecting operation is not limited thereto. For example, to achieve highly accurate control, stable communication between the master device 11 and the slave devices is important, and the magnitude of fluctuation of transmission delay time may be more significant than the length of transmission delay time. Specifically, control using a communication path on which the average transmission delay time is large but the fluctuation of the transmission delay time is small may result in more accurate control than control using a communication path on which the average transmission delay time is small but the fluctuation of the transmission delay time is large. Thus, the master device 11 may measure the fluctuation of transmission delay time of each of selectable communication paths and select a communication path with the smallest fluctuation.

In addition, the master device 11 holds the results of transmission delay time measurement as illustrated in FIG. 22, and in a case where communication through a selected communication path is disconnected because of a failure of a slave device or a connection failure, the master device 11 can select a new communication path by referring to the held measurement results without performing the path searching operation again. For example, in a case where communication with the slave device 23 with the ID ‘C’ via the slave device 21 with the ID ‘B’ has become disconnected when the held measurement results are as illustrated in FIG. 22, the master device 11 selects, as a new path, a path with the second smallest transmission delay time after the path passing through the slave device 21, that is, specifically, a path with the transmission delay time being ‘6’. Thus, the master device 11 selects, as a communication path to/from the slave device 23, the path to the slave device 23 via the slave device 23 with the ID ‘D’. While a case where a communication path between the master device 11 and the slave device 22 is newly selected has been explained, a communication path between the master device 11 and another slave device can be newly selected in a similar manner. As described above, in a case where the master device 11 according to the embodiment is applied to a network having a physical mesh structure to build a network having a logical tree structure, when a problem occurs and communication is disconnected on a certain communication path after the transmission delay times are measured once and an ideal logical network is thus built, it is possible to build a second ideal logical network, that is, a logical network in which the path on which communication is disconnected is switched to a path with the second shortest transmission delay time after the disconnected path by using the held measurement results without performing path search again.

As described above, in the communication network according to the embodiment, a communication device performs communication path setting by transmitting a search frame including information on the transmission port, information on the reception port, and identification information of the communication device through respective communication ports in operation, and collecting information indicating physical connections between respective communication devices forming the communication network. In addition, upon receiving a search frame from another communication device, the communication device performs a transfer process on the basis of information included in the search frame. In this process, the communication device adds, where necessary, information on the port that has received the search frame, the identification information of the communication device, and information on the port through which the search frame is to be transmitted to the search frame to be transferred. This enables the communication device according to the embodiment to obtain the entire configuration of the communication network. As a result, the communication device is capable of selecting a suitable communication path in the industrial network from all the selectable communication paths.

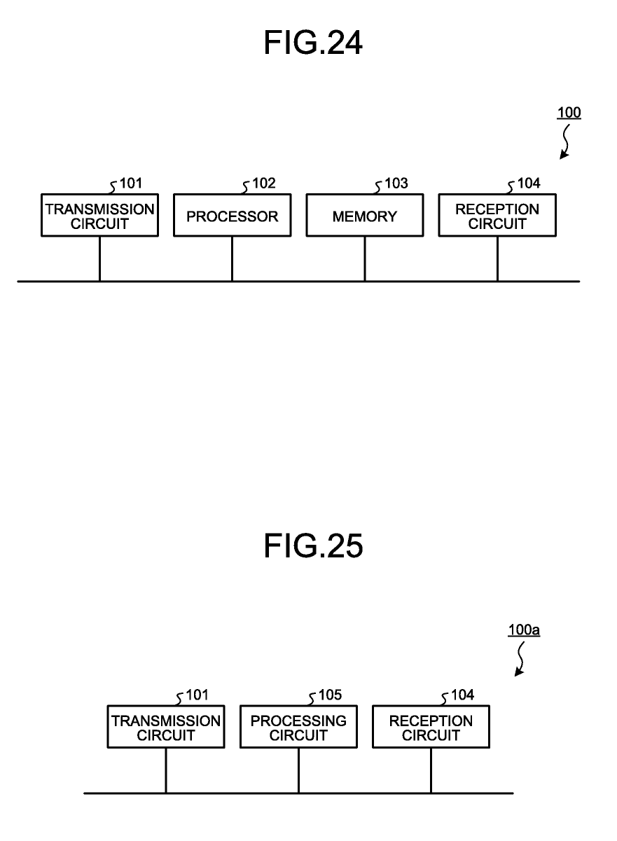

Here, hardware for implementing the communication devices will be described. FIG. 24 is a diagram illustrating an example hardware configuration for implementing the communication device having the configuration illustrated in FIG. 2.

The communication device according to the embodiment can be implemented by a control circuit 100 illustrated in FIG. 24. The control circuit 100 includes a transmission circuit 101, a processor 102, a memory 103, and a reception circuit 104. The transmission circuit 101 is a circuit that transmits signals through transmission/reception ports, which are not illustrated in FIG. 24. The processor 102 is a central processing unit (CPU; also referred to as a central processing device, a processing device, a computing device, a microprocessor, a microcomputer, a processor or a digital signal processor (DSP)), a system large scale integration (LSI), or the like. The memory 103 is a nonvolatile or volatile semiconductor memory such as a random access memory (RAM), a read only memory (ROM), a flash memory, and an erasable programmable read only memory (EPROM), an electrically erasable programmable read only memory (EEPROM) (registered trademark), a magnetic disk, a flexible disk, an optical disk, a compact disc, a mini disc, a digital versatile disc (DVD), or the like. The reception circuit 104 is a circuit that receives signals through transmission/reception ports, which are not illustrated in FIG. 24.

The received frame analyzing unit 230, the transmission frame generating unit 231, the state managing unit 232, and the timer managing unit 233 can be implemented by reading corresponding programs from the memory 103 and executing the read programs by the processor 102. In addition, the information storage unit 234 is implemented by the memory 103. The memory 103 is also used as a temporary memory in processes performed by the processor 102. In addition, the transmission units 221 to 224 are implemented by the transmission circuit 101, and the reception units 225 to 228 are implemented by the reception circuit 104.

Alternatively, the received frame analyzing unit 230, the transmission frame generating unit 231, the state managing unit 232, and the timer managing unit 233 may be implemented by dedicated hardware.

FIG. 25 is a hardware configuration diagram in a case where the received frame analyzing unit 230, the transmission frame generating unit 231, the state managing unit 232, and the timer managing unit 233 are implemented by dedicated hardware. A control circuit 100a illustrated in FIG. 25 includes a processing circuit 105 instead of the processor 102 and the memory 103 illustrated in FIG. 24. The processing circuit 105 is dedicated hardware for implementing the received frame analyzing unit 230, the transmission frame generating unit 231, the state managing unit 232, and the timer managing unit 233. The processing circuit 105 is a single circuit, a composite circuit, a programmed processor, a parallel-programmed processor, an application specific integrated circuit (ASIC), a field programmable gate array (FPGA), or a circuit of a combination thereof.

Note that some of the received frame analyzing unit 230, the transmission frame generating unit 231, the state managing unit 232, and the timer managing unit 233 may be implemented by the processing circuit 105, and the others by the processor 102 and the memory 103 illustrated in FIG. 24.

The configurations presented in the embodiment above are examples of the present invention, and can be combined with other known technologies or can be partly omitted or modified without departing from the scope of the present invention.

### REFERENCE SIGNS LIST

1 to 4, 211 to 214 transmission/reception port; 11, 21 to 24, 200 communication device; 221 to 224 transmission unit; 225 to 228 reception unit; 230 received frame analyzing unit; 231 transmission frame generating unit; 232 state managing unit; 233 timer managing unit; 234 information storage unit; 241 routing analyzing unit; 242 synchronization accuracy analyzing unit; 243 configuration search analyzing unit; 251 frame generating unit; 252 frame transferring unit.

1. A communicator that forms a communication network, the communicator comprising:
circuitry configured to
generate a search frame, the search frame being a frame for searching for a communication path in setting a communication path to/from another communicator,
transmit the search frame to communicators, and
select a communication path with a shortest delay time to each of the other communicators on the basis of information in the search frame having passed through other communicators and returned to the communicator,
wherein when generating the search frame, the communicator includes identification information of the communicator, and information on a port through which the search frame is to be transmitted in the search frame, and upon receiving a search frame generated by another communicator, the communicator adds information on a port through which the search frame has been received, the identification information of the communicator, and information on a port through which the search frame is to be transmitted to the received search frame, and transfers the resulting search frame, and
wherein when a port other than the port through which the search frame has been received is present, the communicator transmits the search frame resulting from addition of the information on the port through which the search frame has been received, the identification information of the communicator, and the information on the port through which the search frame is to be transmitted through each port in operation, or when no port other than the port through which the search frame has been received is present, the communicator transmits the search frame resulting from addition of the information on the port through which the search frame has been received, the identification information of the communicator, and the information on the port through which the search frame is to be transmitted through the port through which the search frame has been received.

2-3. (canceled)

4. The communicator according to claim 1, comprising:
an information memory to store information included in a response frame in response to the search frame transmitted to the other communicators; and
processing circuitry configured as an information analyzer to analyze the information stored in the information memory to identify an entire configuration of the communication network so that a transmission delay time between the communicator and each of the other communicators becomes shortest.

5. The communicator according to claim 4, further comprising:
the processing circuitry further configured as a path selector to select communication paths in the communication network on the basis of the entire configuration of the communication network so that communication paths between the communicator and the other communicators have a tree structure.

6. A communication network comprising:
a controller; and
an actuator, the controller being a master communication device, the actuator being a slave communication device, wherein
the controller includes identification information of the controller and information on a port through which a search frame for searching for a communication path is to be transmitted in the search frame, and transmits the search frame to the actuator, and
upon receiving the search frame, the actuator adds information on a port through which the search frame has been received, identification information of the actuator, and information on a port through which the search frame is to be transmitted to the received search frame, and transfers the resulting search frame, wherein the actuator adds the information on the port through which the search frame has been received, the identification information of the actuator, and the information on the port through which the search frame is to be transmitted to the received search frame to obtain a search frame to be transferred, and when a port in operation other than the port through which the search frame has been received is present, transmits the search frame to be transferred through each port in operation, or when no port in operation other than the port through which the search frame has been received is present, transmits the search frame to be transferred through the port through which the search frame has been received.

7. (canceled)
